(19) United States
(12) Patent Application Publication
(10) Pub. No.: US 2013/0196059 A1
(43) Pub. Date: Aug. 1, 2013

(54) METHOD FOR PRODUCING COLOR FILTER

(71) Applicants: Mihoko Kurashige, Tokyo-to (JP); Tomonori Nishida, Tokyo-to (JP); Masato Tezuka, Tokyo-to (JP); Makiko Shirato, Tokyo-to (JP); Remi Ohshiro, Tokyo-to (JP); Ryutaro Harada, Tokyo-to (JP); Takayuki Tazaki, Tokyo-to (JP)

(72) Inventors: Mihoko Kurashige, Tokyo-to (JP); Tomonori Nishida, Tokyo-to (JP); Masato Tezuka, Tokyo-to (JP); Makiko Shirato, Tokyo-to (JP); Remi Ohshiro, Tokyo-to (JP); Ryutaro Harada, Tokyo-to (JP); Takayuki Tazaki, Tokyo-to (JP)

(73) Assignee: DAI NIPPON PRINTING CO., LTD., Tokyo-to (JP)

(21) Appl. No.: 13/879,174

(22) PCT Filed: Oct. 25, 2011
(86) PCT No.: PCT/JP2011/074558

§ 371 Date: Apr. 12, 2013

(30) Foreign Application Priority Data
Nov. 4, 2010 (JP) 2010-247851

(51) Int. Cl. B05D 5/06

(52) U.S. Cl. CPC B05D 5/061
USPC 427/164

(57) ABSTRACT

A method for producing a color filter, by which a highly flat coloring layer can be efficiently formed even in the case of using an inkjet method, comprising steps of: an inkjet step of applying a coloring layer-forming coating liquid by an inkjet method at an opening of a black matrix substrate which includes a transparent substrate and a light shielding part that is formed on the transparent substrate and has the opening, and thereby forming a pre-drying coloring layer; a reduced-pressure drying treatment step of subjecting the pre-drying coloring layer to a reduced-pressure drying treatment, and forming a color filter substrate having a post-drying coloring layer formed thereon; and a baking treatment step of subjecting the color filter substrate to a prebaking treatment and subsequently to a post-baking treatment, and obtaining a color filter having a coloring layer formed thereon, wherein in the reduced-pressure drying treatment, the pre-drying coloring layer is subjected to the reduced-pressure drying treatment such that a film thickness of an edge of the post-drying coloring layer is not smaller than a film thickness of the light shielding part.

### TECHNICAL FIELD

The present invention relates to a method for producing a color filter, by which a color filter having a satisfactory display quality when used in a liquid crystal display apparatus can be easily produced.

### BACKGROUND ART

In recent years, along with the development of personal computers, and particularly with the development of portable personal computers, the demand for liquid crystal displays is increasing. Furthermore, recently, the supply rate of liquid crystal TV sets for domestic use is also increasing, and in the current situation, the market for liquid crystal displays is still expanding. Moreover, the liquid crystal displays that have been spread in recent years tend to have large screens, and particularly in regard to liquid crystal TV sets for domestic use, the tendency is becoming stronger.

Under such circumstances, regarding the members that constitute liquid crystal displays, it is desirable to produce high-quality products at lower cost. Particularly, since color filters that have a function of converting liquid crystal displays into color displays, are conventionally expensive, such a demand is ever increasing.

Here, a color filter used in a general liquid crystal display usually comprises a substrate, a light shielding part that is formed on the substrate and includes a plurality of openings, and coloring layers of the respective colors of red (R), green (G) and blue (B) that are formed within the openings.

Further, when the electrodes corresponding to the respective colors of R, G and B of such a color filter are turned on and off, the liquid crystals operate as shutters for the backlight, and light passes through the respective pixels of R, G and B, thus achieving color display.

Regarding the method for producing such a color filter, conventional methods include production methods using a dyeing method, a pigment dispersing method and the like. However, as a method which enables production of color filters with higher productivity at lower cost as compared with these methods, recently attention has been paid to a method for producing a color filter by using an inkjet method (Patent Literature 1).

In such a method for producing a color filter by using an inkjet method, first, a coloring layer-forming coating liquid, which contains a solvent, is applied at an opening of the light shielding part on a substrate by using an inkjet apparatus, and thereby, a pre-drying coloring layer is formed. Thereafter, the solvent included in the pre-drying coloring layer is removed by drying, and then the pre-drying coloring layer is heated. Thereby, a coloring layer is formed.

Furthermore, in recent years, for the process of removal by drying, a reduced-pressure drying apparatus that dries the coloring layer in an environment under reduced pressure is used (Patent Literatures 2 to 6).

However, in regard to a color filter formed by the inkjet method, from the relations of the affinity between the coloring layer-forming coating liquid and the surface of the light shielding part, the height of the light shielding part, the amount of the coloring layer-forming coating liquid discharged from the inkjet apparatus, and the like, the shape of the coloring layer at an opening surrounded by the light shielding part may become a shape in which the film thickness at the edges of the coloring layer is small, while the film thickness at the center of the coloring layer is larger. Also, when the film thickness difference between the maximum thickness and the minimum thickness of the coloring layer is large, there is a problem that when the coloring layer is employed in a liquid crystal display apparatus, there is a risk that the display quality may be adversely affected thereby.

As a method for solving such a problem, in the case of using a reduced-pressure drying apparatus which performs drying in an environment under reduced pressure, an investigation has been conducted on a method of reducing the film thickness difference by not completely drying the coloring layer, but stopping drying in the middle of the drying process, and heating the coloring layer that has been subjected to a reduced-pressure drying treatment (hereinafter, may be referred to as a post-drying coloring layer in the following descriptions) while allowing the coloring layer to have fluidity to a certain degree, and thus flattening the coloring layer.

However, the content of the solvent that is contained in the post-drying coloring layer varies depending on the extent of the reduced-pressure drying treatment, and if the content of the solvent in the post-drying coloring layer is too large, or if the content is too small, there is a possibility that a problem such as described below may occur.

If the content of the solvent in the post-drying coloring layer is large, there is a risk that bumping of the solvent contained in the post-drying coloring layer may occur during the prebaking treatment which is a heating process, and may thereby overflow the respective openings compartmentalized by the light shielding part to have the colors mixed up between the coloring layers. Furthermore, in order to solve this problem, it can also be considered to carry out the treatment at a temperature lower than the temperature employed in a conventional prebaking treatment over a long time; however, in this case, there is a problem that the production efficiency for the color filter may decrease to a large extent.

Furthermore, if the content of the solvent in the post-drying coloring layer is small, there is a problem that there is a possibility that it may be difficult to impart desired flatness to the coloring layer to be formed.

Thus, conditions for a reduced-pressure drying treatment, under which desire flatness can be imparted to the coloring layer to be formed, and the prebaking treatment can be carried out in a short time, have been required.

Furthermore, when coloring layers of a plurality of colors having different film thicknesses are simultaneously formed by the method described above, there is a possibility that a problem such as described below may occur.

That is, a color filter is usually formed with coloring layers of three colors, namely, red, green and blue as described above; however, depending on the kind of the liquid crystal display apparatus to be used, it is necessary to optimize the cell gaps for each color. Particularly, it may be required to increase the film thickness of the blue coloring layer. In such a case, when flattening such as described above is carried out, it is necessary to increase the amount to be held of the coating liquid for forming a blue layer. Therefore, when the reduced-pressure drying treatment and the prebaking treatment are carried out under the same conditions as those used for the coloring layers of other colors, there will be more of the solvent contained in the post-drying coloring layer of blue color than the solvent contained in the post-drying coloring layer of other colors. Therefore, bumping of the solvent contained in the post-drying coloring layer of blue color occurs at the time of the prebaking treatment, and there is a possibility that a problem of color mixing with the coloring layers of other colors may occur. Furthermore, generally, regarding a blue coloring layer-forming coating liquid that is intended to form a blue coloring layer, a coating liquid having a low pigment concentration and high fluidity may be used. Even in this case, when a flattening treatment as described above is similarly carried out, there is a possibility that a problem of color mixing with the coloring layers of other colors may occur.

As there have been such problems as described above, it is conventionally difficult to simultaneously form coloring layers of a plurality of colors having different height by using an inkjet method, and it is necessary to form coloring layers having different film thicknesses separately. Therefore, the process for forming a coloring layer by using the inkjet method described above must be carried out at least two times, and therefore, it has been difficult to increase the production efficiency.

Thus, in the case of simultaneously forming coloring layers of a plurality of colors having different height by using an inkjet method, conditions for a reduced-pressure drying treatment under which desired flatness can be respectively imparted to the coloring layers of a plurality of colors to be formed, and color mixing of the coloring layers of various colors does not occur, are required.

### CITATION LIST

### Patent Literature

Patent Literature 1: Japanese Application Publication No. (JP-A) 2000-187111
Patent Literature 2: JP 2000-111252
Patent Literature 3: JP H10-002665
Patent Literature 4: JP H09-320949
Patent Literature 5: JP H07-008704 Patent Literature 6: JP H06-097061

### SUMMARY OF INVENTION

### Technical Problem

The present invention was made in view of the situation described above, and it is a main object of the present invention to provide a method for producing a color filter, by which a highly flat coloring layer can be efficiently formed even in the case of using an inkjet method.

### Solution to Problem

The inventors of the present invention conducted thorough investigations in order to solve the problem described above, and as a result, the inventors found the conditions for the reduced-pressure drying treatment in which the content of the solvent in a post-drying coloring layer can be set to the minimum content with which desired flatness can be imparted to the coloring layer to be formed and a prebaking treatment can be carried out in a short time.

Furthermore, the inventors of the present invention found that when the conditions for a reduced-pressure drying treatment described above are used, even if coloring layers of a plurality of colors having different film thicknesses are simultaneously formed by using an inkjet method, a color filter in which desired flatness can be imparted to the respective coloring layers and color mixing does not occur in the coloring layers of various colors, can be obtained. As a result, the inventors found that a plurality of coloring layers having different film thicknesses can be formed by performing a process for forming a coloring layer by using an inkjet method only once, and therefore, the production efficiency of the color filter can be enhanced to a large extent. Thus, the inventors completed the present invention.

That is, the present invention provides a method for producing a color filter, comprising steps of: an inkjet step of applying coloring layer-forming coating liquid by an inkjet method at an opening of a black matrix substrate which includes a transparent substrate and a light shielding part that is formed on the transparent substrate and has the opening, and thereby forming a pre-drying coloring layer; a reduced-pressure drying treatment step of subjecting the pre-drying coloring layer to a reduced-pressure drying treatment, and forming a color filter substrate having a post-drying coloring layer formed thereon; and a baking treatment step of subjecting the color filter substrate to a prebaking treatment and subsequently to a post-baking treatment, and obtaining a color filter having a coloring layer formed thereon, wherein in the reduced-pressure drying treatment step, the pre-drying coloring layer is subjected to the reduced-pressure drying treatment such that a film thickness of an edge of the post-drying coloring layer is not smaller than a film thickness of the light shielding part.

According to the present invention, by subjecting the pre-drying coloring layers to a reduced-pressure drying treatment such that the film thickness of the edge of the post-drying coloring layer is not smaller than the film thickness of the light shielding part in the reduced-pressure drying treatment step, flatness of the coloring layer of the color filter that is produced by the production method of the present invention can be improved. Furthermore, since a prebaking treatment can be carried out in a short time, the production efficiency for the color filter can be increased.

The present invention provides a method for producing a color filter, comprising steps of: an inkjet step of applying a coloring layer-forming coating liquid by an inkjet method at an opening of a black matrix substrate which includes a transparent substrate and a light shielding part that is formed on the transparent substrate and has the opening, and thereby forming a pre-drying coloring layer; a reduced-pressure drying treatment step of subjecting the pre-drying coloring layer to a reduced-pressure drying treatment, and forming a color filter substrate having a post-drying coloring layer formed thereon; and a baking treatment step of subjecting the color filter substrate to a prebaking treatment and subsequently to a post-baking treatment, and obtaining a color filter having a coloring layer formed thereon, wherein in the reduced-pressure drying treatment step, the pre-drying coloring layer is subjected to the reduced-pressure drying treatment such that the ratio of a maximum film thickness of the post-drying coloring layer and a width of the opening is in the range of 7.8×10⁻³ to 2.3×10⁻¹ when the width of the opening is taken as 1.

According to the present invention, by subjecting the pre-drying coloring layer to a reduced-pressure drying treatment in the reduced-pressure drying treatment step such that the ratio of the maximum film thickness of the post-drying coloring layer and the width of the opening is in the range mentioned above, flatness of the coloring layer of the color filter that is produced by the production method of the present invention can be increased. Furthermore, since a prebaking treatment can be carried out in a short time, the production efficiency for the color filter can be increased.

The present invention provides a method for producing a color filter which comprises a black matrix substrate having a transparent substrate and a light shielding part that is formed on the transparent substrate and has openings, and coloring layers of a plurality of colors formed at the openings on the black matrix substrate, with the coloring layers of a plurality of colors being formed such that a film thickness of a coloring layer of at least one color among the coloring layers of a plurality of colors is smaller than a film thickness of coloring layers of other colors, the method comprising steps of: an inkjet step of applying coloring layer-forming coating liquids at the openings of the black matrix substrate by an inkjet method and thereby forming pre-drying coloring layers of a plurality of colors; a reduced-pressure drying treatment step of subjecting the pre-drying coloring layers of a plurality of colors to a reduced-pressure drying treatment, and forming a color filter substrate having post-drying coloring layers of a plurality of colors formed thereon; and a baking treatment step of subjecting the color filter substrate to a prebaking treatment and subsequently to a post-baking treatment, and obtaining a color filter having the coloring layers of a plurality of colors formed thereon, wherein in the reduced-pressure drying treatment step, the pre-drying coloring layers of a plurality of colors are subjected to the reduced-pressure drying treatment such that a film thickness of an edge of a post-drying coloring layer having the smallest film thickness is not smaller than a film thickness of the light shielding part.

According to the present invention, the content of the solvent in the post-drying coloring layer having the smallest film thickness among the coloring layers of a plurality of colors can be set to the minimum content with which desired flatness can be imparted to the coloring layers to be formed and a prebaking treatment can be carried out in a short time. Therefore, coloring layers having other film thicknesses can be formed by applying coloring layer-forming coating liquids into thick films so that post-drying coloring layers having a film thickness of the extent that bumping of the solvent in the post-drying coloring layers does not occur under the conditions of the prebaking treatment, are obtained. Therefore, even if coloring layers of a plurality of colors with different film thicknesses have been simultaneously formed by an inkjet method, desired flatness can be imparted to the respective coloring layers, and color mixing of the coloring layers of various colors can be prevented.

The present invention provides a method for producing a color filter which comprises a black matrix substrate having a transparent substrate and a light shielding part that is formed on the transparent substrate and has openings, and coloring layers of a plurality of colors formed at the openings on the black matrix substrate, with the coloring layers of a plurality of colors being formed such that a film thickness of the coloring layer of at least one color among the coloring layers of a plurality of colors is smaller than a film thickness of coloring layers of other colors, the method comprising steps of: an inkjet step of applying coloring layer-forming coating liquids at the openings of the black matrix substrate by an inkjet method and thereby forming pre-drying coloring layers of a plurality of colors; a reduced-pressure drying treatment step of subjecting the pre-drying coloring layers of a plurality of colors to a reduced-pressure drying treatment, and forming a color filter substrate having post-drying coloring layers of a plurality of colors formed thereon; and a baking treatment step of subjecting the color filter substrate to a prebaking treatment and subsequently to a post-baking treatment, and obtaining a color filter having the coloring layers of a plurality of colors formed thereon, wherein in the reduced-pressure drying treatment step, the pre-drying coloring layers of a plurality of colors are subjected to the reduced pressure drying treatment such that a ratio of a maximum thickness of the post-drying coloring layer having the smallest film thickness and a width of the opening is in the range of 7.8×10⁻³ to 2.3×10⁻¹ when the width of the opening is taken as 1.

According to the present invention, by including the reduced-pressure drying treatment step described above, the content of the solvent in the post-drying coloring layer having the smallest film thickness among the coloring layers of a plurality of colors can be set to the minimum content with which desired flatness can be imparted to the coloring layers to be formed and the prebaking treatment can be carried out in a short time. Therefore, coloring layers having other film thicknesses can be formed by applying coloring layer-forming coating liquids into thick films so that post-drying coloring layers having a film thickness of the extent that bumping of the solvent in the post-drying coloring layers does not occur under the conditions of the prebaking treatment, are obtained. Therefore, even if coloring layers of a plurality of colors with different film thicknesses have been simultaneously formed by an inkjet method, desired flatness can be imparted to the respective coloring layers, and color mixing of the coloring layers of various colors can be prevented.

According to the present invention, it is preferable that the coloring layers of a plurality of colors include a red coloring layer, a green coloring layer and a blue coloring layer, and the red coloring layer and the green coloring layer have a same film thickness, while this film thickness is smaller than a film thickness of the blue coloring layer. By employing the configuration described above, a color filter which can have an increased luminance of the blue pixel region when used in a liquid crystal display apparatus, can be obtained.

According to the present invention, in the baking treatment step, it is preferable that the prebaking treatment be carried out at a temperature in the range of 70° C. to 110° C. It is because when the prebaking treatment is carried out at a temperature in the range mentioned above, flatness of the coloring layers can be further enhanced.

### Advantageous Effects of Invention

The method for producing a color filter of the present invention can impart desired flatness to the coloring layers that are formed, and enable the prebaking treatment to be carried out in a short time. Therefore, an operating effect that a method for producing a color filter with high production efficiency can be provided, is offered.

### BRIEF DESCRIPTION OF DRAWINGS

FIGS. 1A to 1D are a process diagram illustrating an example of the method for producing a color filter of the present invention.

FIG. 2 is a schematic cross-sectional view illustrating an example of the color filter substrate that is formed in the method for producing a color filter of the present invention.

FIG. 3 is a schematic plan view illustrating an example of the color filter that is produced by the method for producing a color filter of the present invention.

FIGS. 4A and 4B are a process diagram illustrating an example of the prebaking treatment in the method for producing a color filter of the present invention.

FIGS. 5A and 5B are a process diagram illustrating an example of the prebaking treatment in the method for producing a color filter.

FIGS. 6A to 6D are a process diagram illustrating another example of the method for producing a color filter of the present invention.

### DESCRIPTION OF EMBODIMENT

Hereinafter, the method for producing a color filter of the present invention will be described in detail.

The method for producing a color filter of the present invention is a production method in which in the reduced-pressure drying treatment step, a pre-drying coloring layer is subjected to a reduced-pressure treatment under the conditions for a reduced-pressure drying treatment under which the content of the solvent in a post-drying coloring layer can be set to the minimum content with which desired flatness can be imparted to the coloring layer to be formed, and a prebaking treatment can be carried out in a short time.

For a color filter that is produced by the production method of the present invention, when it is said that a coloring layer has desired flatness, it is implied that the coloring layer is given a flatness of the extent that when the color filter is used in a liquid crystal display apparatus, satisfactory image display can be achieved. Specifically, it is implied that the film thickness difference between the maximum film thickness of the coloring layer and the minimum film thickness of the coloring layer is 0.6 μm or less.

Incidentally, the maximum film thickness of a coloring layer refers to a film thickness that becomes the maximum for the film thickness of a coloring layer formed at an opening of the light shielding part, and the minimum film thickness of a coloring layer refers to a film thickness that becomes the minimum for the film thickness of a coloring layer formed at an opening of the light shielding part.

Incidentally, regarding the maximum film thickness and minimum film thickness according to the present invention, the values measured by using a light interference type three-dimensional non-contact surface profilometer (for example, trade name: MICROMAP 557N manufactured by US Micromap Corp.) are used.

Furthermore, according to the present invention, when it is said that a prebaking treatment can be carried out in a short time, it is implied that when a prebaking treatment is carried out at the treatment temperature and treatment time used in a prebaking treatment that is carried out upon the production of a general color filter, bumping of the solvent in the post-drying coloring layer does not occur.

Here, when it is said that bumping of the solvent in a post-drying coloring layer does not occur, it is implied that while the boiling point of the solvent used in a coloring layer-forming coating liquid for a color filter is in the range of 150° C. to 300° C., when a prebaking treatment is carried out at a temperature in the range of 70° C. to 110° C. as the treatment temperature for the prebaking treatment, bumping of the solvent in the post-drying coloring layer and color mixing between adjacent coloring layers do not occur. Incidentally, the details of the prebaking treatment temperature will be described below, and thus, further description will not be given here.

Specific examples of the conditions for a reduced-pressure drying treatment include two conditions for a reduced-pressure drying treatment, namely, a condition under which a dried state is achieved such that the film thickness of the edges of a coloring layer obtained after reduced-pressure drying is not smaller than the film thickness of the light shielding part; and a condition under which a dried state is achieved such that the ratio of the maximum film thickness of a coloring layer obtained after reduced-pressure drying and the width of an opening that forms a coloring layer is in a predetermined range.

Hereinafter, the method for producing a color filter of the present invention will be explained in two separate embodiments, due to the difference in the conditions for the reduced-pressure drying treatment described above.

1. Method for Producing Color Filter of First Embodiment

The first embodiment of the method for producing a color filter of the present invention will be described.

The method for producing a color filter of the present embodiment is a production method comprising steps of: an inkjet step of applying by an inkjet method a coloring layer-forming coating liquid at an opening of a black matrix substrate which includes a transparent substrate and a light shielding part that is formed on the transparent substrate and has the opening, and thereby forming a pre-drying coloring layer; a reduced-pressure drying treatment step of subjecting the pre-drying coloring layer to a reduced-pressure drying treatment, and forming a color filter substrate having a post-drying coloring layer formed thereon; and a baking treatment step of subjecting the color filter substrate to a prebaking treatment and subsequently to a post-baking treatment, and obtaining a color filter having a coloring layer formed thereon, wherein in the reduced-pressure drying treatment step, the pre-drying coloring layer is subjected to the reduced-pressure drying treatment such that the film thickness of an edge of the post-drying coloring layer is not smaller than the film thickness of the light shielding part.

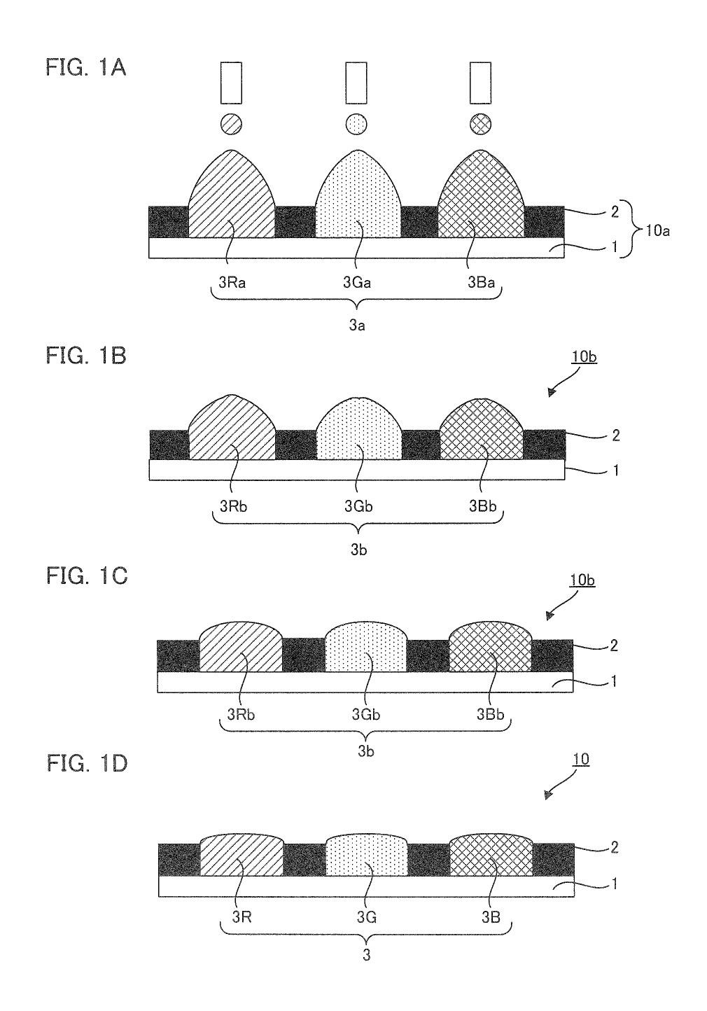

The method for producing a color filter of the present embodiment will be described by using the drawings. FIGS. 1A to 1D are a process diagram illustrating an example of the method for producing a color filter of the present embodiment. Here, FIGS. 1A to 1D illustrate an example of simultaneously forming a red coloring layer, a green coloring layer and a blue coloring layer, all of which have an equal film thickness. As shown in FIGS. 1A to 1D, in the method for producing a color filter of the present embodiment, first, an inkjet process (FIG. 1A) of applying coloring layer-forming coating liquids by an inkjet method at openings of a black matrix substrate 10a which includes a transparent substrate 1 and a light shielding part 2 that is formed on the transparent substrate 1 and has the openings, and thereby forming pre-drying coloring layers 3a (in FIG. 1A, red pre-drying coloring layer 3Ra, green pre-drying coloring layer 3Ga, and blue pre-drying coloring layer 3Ba), is carried out. Next, a reduced-pressure drying treatment process (FIG. 1B) of subjecting the pre-drying coloring layers 3a to a reduced-pressure drying treatment, and thereby forming a color filter substrate 10b having post-drying coloring layers 3b (in FIG. 1B, a red post-drying coloring layer 3Rb, a green post-drying coloring layer 3Gb, and a blue post-drying coloring layer 3Bb) formed thereon, is carried out. Next, the color filter substrate 10b is subjected to a prebaking treatment (FIG. 1C), and then a baking treatment process (FIG. 1D) of subjecting the color filter substrate to a post-baking treatment, and obtaining a color filter 10 having coloring layers 3 (in FIG. 1D, a red coloring layer 3R, a green coloring layer 3G, and a blue coloring layer 3B) formed thereon, is carried out. In the present embodiment, a color filter 10 is produced through the above-described processes.

Furthermore, the present embodiment is a production method in which, in the reduced-pressure drying treatment process, the pre-drying coloring layers are subjected to a reduced-pressure drying treatment such that the film thickness of the edges of the post-drying coloring layers is not smaller than the film thickness of the light shielding part.

Here, the “film thickness of the edge(s) of the post-drying coloring layer(s)” refers to the film thickness of an area which is in a post-drying coloring layer that is formed at an opening compartmentalized in the light shielding part, and is in contact with the light shielding part.

Furthermore, the “film thickness of the light shielding part” refers to the film thickness of the light shielding part before the baking treatment process.

Also, when it is said “the film thickness of the edge(s) of post-drying coloring layer(s) is not smaller than the film thickness of the light shielding part”, it is implied that the film thickness difference between the film thickness of the edge(s) of the post-drying coloring layer(s) and the film thickness of the light shielding part is 0.1 μm or less, preferably 0.05 μm or less, and particularly 0 μm.

Incidentally, for the film thickness of the edges of the post-drying coloring layers and the film thickness of the light shielding part, the values measured by using a light interference type three-dimensional non-contact surface profilometer (for example, trade name: MICROMAP 557N manufactured by US Micromap Corp.) are used.

The film thickness of the edges of a post-drying coloring layer is determined by the extent of the reduced-pressure drying treatment, that is, the content of the solvent of the post-drying coloring layer. Here, the content of the solvent in a post-drying coloring layer that is formed at an opening having a certain area defined by the width of a certain opening, is correlated to a certain extent with the maximum film thickness of the post-drying coloring layer. Thus, as the content of the solvent in a post-drying coloring layer is larger, the maximum film thickness becomes larger, and as the content of the solvent is smaller, the maximum film thickness becomes smaller. Therefore, in regard to the phrase “the film thickness of the edge (s) of post-drying coloring layer (s) is not smaller than the film thickness of the light shielding part” according to the present embodiment, the condition can also be expressed by using the ratio of the maximum film thickness of the post-drying coloring layer and the width of the opening.

Such a ratio of the maximum film thickness of a post-drying coloring layer and the width of the opening is adjusted in the range of 7.8×10⁻³ to 2.3×10⁻¹, preferably in the range of 1.3×10⁻² to 1.8×10⁻¹, and particularly in the range of 1.8×10⁻² to 1.6×10⁻¹, when the width of the opening is taken as 1.

Incidentally, the ratio of the maximum film thickness of the post-drying coloring layer and the width of the opening is a value represented by t/u, when the maximum film thickness of the post-drying coloring layer is designated as “t”, and the width of the opening is designated as “u”.

Furthermore, for the maximum film thickness “t” of a post-drying coloring layer and the width “u” of an opening, the values measured by using a light interference type three-dimensional non-contact surface profilometer (for example, trade name: MICROMAP 557N manufactured by US Micromap Corp.) are used.

As a specific example of a method for calculating the ratio, when the film thickness of the light shielding part before shrinking in advance to the baking treatment process is set to 2.7 μm, the width u1 of the opening shown in FIG. 3 is set to the range of 100 μm to 480 μm, the width “u2” of the opening is set to the range of 130 μm to 600 μm, and the maximum film thickness of a post-drying coloring layer after reduced-pressure drying is set to +2 μm to +20 μm, among others +5 μm to +15 μm, and particularly +8 μm to +13 μm, with the film thickness of the light shielding part taken as the reference, the value range can be calculated. Incidentally, explanation on FIG. 3 will be given below.

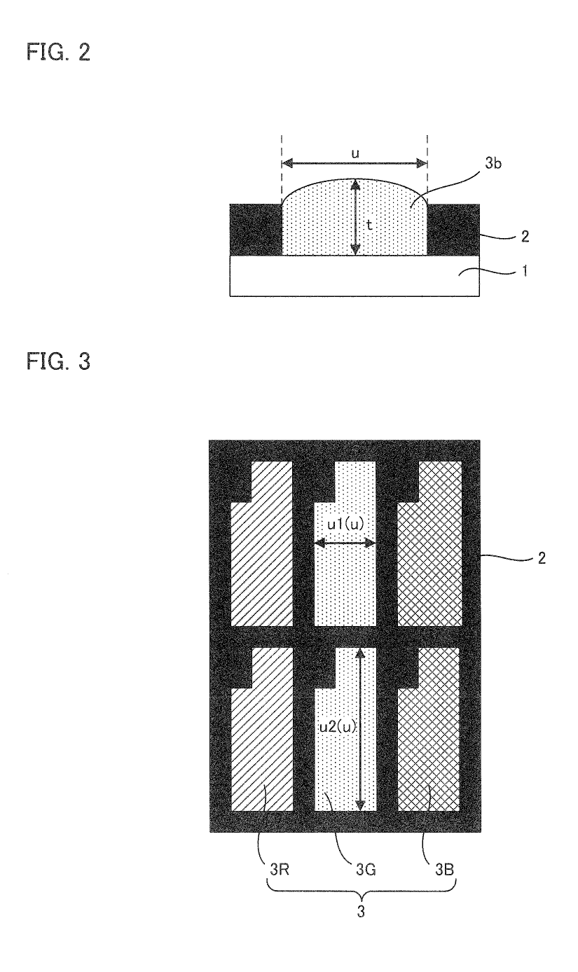

Here, the “maximum film thickness of a post-drying coloring layer” according to the present embodiment refers to the maximum film thickness of a post-drying coloring layer obtained after a reduced-pressure drying treatment, and in FIG. 2, the maximum film thickness of a post-drying coloring layer is meant to refer to the distance represented by “t”.

Also, the “width of an opening” means the width of an opening that is compartmentalized in the light shielding part, and in FIG. 2, the width of an opening is meant to refer to the distance represented by “u”. Furthermore, regarding the “width of an opening” according to the present embodiment, when the shape of the opening of the light shielding part in a color filter is rectangular-shaped as shown in FIG. 3, the width is meant to refer to the shorter side “u1” or the longer side “u2”; and when the opening of the light shielding part has a notched section, the width is meant to refer to the distance in a region that does not have a notched section.

Furthermore, according to the present invention, in regard to the ratio t/u of the maximum film thickness “t” of the post-drying coloring layer and the width “u” of the opening, both t/u1 and t/u2 should satisfy the value range mentioned above.

Incidentally, FIG. 2 is a schematic cross-sectional view illustrating an example of a color filter substrate that is formed in the reduced-pressure drying treatment process according to the present embodiment, and FIG. 3 is a schematic plan view illustrating an example of a color filter that is produced by the production method of the present embodiment. Furthermore, for the symbols which are not described in FIG. 2 and FIG. 3, the same definitions as those used in FIGS. 1A to 1D may be used, and therefore, further explanation will not be repeated here.

Here, the present embodiment is characterized in that it was found that as the conditions for a reduced-pressure drying treatment under which the content of the solvent in the post-drying coloring layer can be adjusted to the minimum content with which desired flatness can be imparted to the coloring layer to be formed, the film thickness of the edges of the post-drying coloring layers should be made not smaller than the film thickness of the light shielding part.

The reason why desired flatness can be imparted to the coloring layer to be formed when the film thickness of the edges of the post-drying coloring layer is made not smaller than the film thickness of the light shielding part, is not clearly understood; however, the following may be speculated.

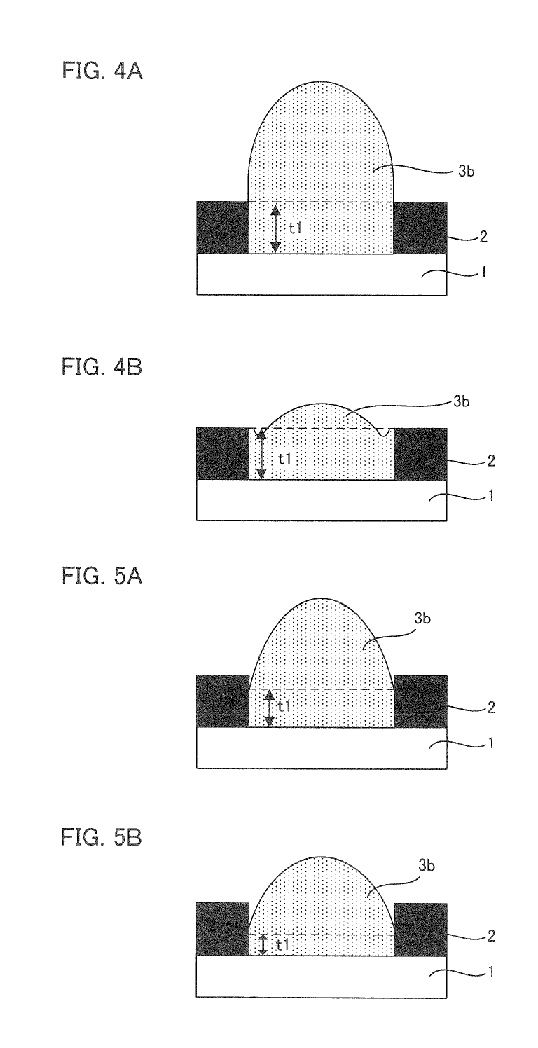

FIGS. 4 and 5 are process diagrams each illustrating an example of the prebaking treatment in the method for producing a color filter. Furthermore, FIG. 4A and FIG. 5A illustrate substrates for color filter before a prebaking treatment, and FIG. 4B and FIG. 5B illustrate substrates for color filter after a prebaking treatment. Incidentally, for the symbols which are not described in FIGS. 4 and 5, the same definitions as those used in FIGS. 1A to 1D may be used, and therefore, further explanation will not be repeated here.

Here, as shown in FIG. 4A, when the post-drying coloring layer 3b is formed such that the film thickness “t1” of the edges of the post-drying coloring layer 3b is not smaller than the film thickness of the light shielding part 2, it is speculated that a minute post-drying coloring layer having a minute film thickness (hereinafter, referred to as a minute coloring layer on top surface of the light shielding part) is formed on the top surface of the light shielding part 2 that is in contact with the post-drying coloring layer 3b. Furthermore, in this case, even in the course in which the film thickness of the post-drying coloring layer 3b decreases as the solvent is volatilized at the time of the prebaking treatment, since the minute coloring layer on top surface of the light shielding part exists at the top surface of the light shielding part 2 that is in contact with the post-drying coloring layer 3b, the edges of the post-drying coloring layer 3b are located on the light shielding part 2, and the post-drying coloring layer 3b that is finally obtained after the prebaking treatment acquires a shape in which there is almost no film thickness difference between the film thickness “t1” of the edges of the post-drying coloring layer 3b and the film thickness of the light shielding part 2, as shown in FIG. 4B.

On the other hand, as shown in FIG. 5A, it is speculated that when the post-drying coloring layer 3b is formed such that the film thickness “t1” of the edges of the post-drying coloring layer is smaller than the film thickness of the light shielding part 2, the above-mentioned minute coloring layer on top surface of the light shielding part is not formed on the top surface of the light shielding part 2 that is in contact with the post-drying coloring layer 3b. In this case, in the course in which the film thickness of the post-drying coloring layer 3b decreases as the solvent is volatilized at the time of the prebaking treatment, since the minute coloring layer on top surface of the light shielding part does not exist on the top surface of the light shielding part 2 that is in contact with the post-drying coloring layer 3b, the film thickness decreases even at the edges of the post-drying coloring layer 3b. Thus, it is speculated that the post-drying coloring layer 3b that is finally obtained after a prebaking treatment acquires a shape in which, as shown in FIG. 5B, the film thickness “t1” of the edges of the post-drying coloring layer 3b is small, and the film thickness difference between the film thickness “t1” of the edges of the post-drying coloring layer 3b and the film thickness of the light shielding part 2 is large.

Here, in the coloring layer-forming coating liquid that is discharged to the openings that are compartmentalized in the light shielding part 2, a certain amount of solid components are contained, and even if the solvent has been removed to a certain extent after a reduced-pressure drying treatment, the amount of the solid components contained in the post-drying coloring layer does not change. Therefore, when the volumes of the post-drying coloring layers are the same, as illustrated in FIG. 4B, as the film thickness difference between the film thickness of the edges of the post-drying coloring layer 3b and the film thickness of the light shielding part is smaller, that is, as the film thickness “t1” of the edges of the post-drying coloring layer 3b is larger, the film thickness of the post-drying coloring layer that is compartmentalized by the light shielding part becomes uniform, and flatness increases. As shown in FIG. 5B, it is speculated that as the film thickness difference between the film thickness of the edges of the post-drying coloring layer 3b and the film thickness of the light shielding part 2 is larger, that is, as the film thickness of the edges “t1” of the post-drying coloring layer 3b is smaller, the film thickness at the center of the post-drying coloring layer 3b becomes larger, thus causing a film thickness difference between the center and the edges of the post-drying coloring layer, and flatness is reduced.

Therefore, according to the present embodiment, when the pre-drying coloring layer is subjected to a reduced-pressure drying treatment in the reduced-pressure drying treatment process such that the film thickness of the edges of the post-drying coloring layer is not smaller than the film thickness of the light shielding part, flatness of the coloring layers of a color filter that is produced by the production method of the present embodiment can be increased. Furthermore, since the prebaking treatment can be carried out in a short time, the production efficiency for the color filter can be increased.

Hereinafter, the various processes in the method for producing a color filter of the present embodiment will be respectively described.

(1) Inkjet Process

The present process is a process of applying coloring layer-forming coating liquids by an inkjet method at the openings of a black matrix substrate which includes a transparent substrate and a light shielding part that is formed on the transparent substrate and has openings, and thereby forming a pre-drying coloring layer.

Hereinafter, the black matrix substrate and coloring layer-forming coating liquid used in the present process, and the pre-drying coloring layer formed by the present process will be respectively explained.

(a) Black Matrix Substrate

The black matrix substrate includes a transparent substrate, and a light shielding part that is formed on the transparent substrate and has openings.

(i) Transparent Substrate

Regarding the transparent substrate, the same transparent substrate as that used in general color filters can be used. Specific examples thereof include non-flexible transparent inorganic substrates made of materials such as quartz glass, Pyrex (registered trademark) glass, or a synthetic quartz plate; and substrates obtained by forming an inorganic film of SiO₂ or the like on the surface of a flexible transparent resin substrate such as a transparent resin film or an optical resin plate. Among them, it is preferable to use an inorganic substrate in the present process. It is because in regard to the black matrix substrate, the light shielding part preferably has liquid repellency, and as a method of making the light shielding part liquid-repellent, a method of making a resin-made light shielding part liquid-repellent by using a fluorine plasma treatment is suitably used.

Furthermore, in regard to the present process, among the inorganic substrates, it is preferable to use a glass substrate, and among the glass substrates, it is preferable to use an alkali-free type glass substrate. It is because the alkali-free type glass substrate has excellent dimensional stability and excellent workability in a high temperature heating treatment, and since the glass does not contain alkali components, the alkali-free type glass substrate can be suitably used in color filters for color liquid crystal display apparatuses of active matrix type.

(ii) Light Shielding Part

The light shielding part is formed on the above-mentioned transparent substrate and has openings.

As the light shielding part used in the present process, a light shielding part in which openings are regularly formed at an equal interval is usually used. Here, the specific shape and the arrangement shape of the opening are not particularly limited, and can be arbitrarily determined in accordance with the use and the like of the color filter produced by the present embodiment. In the present embodiment, it is more preferable that the shape of the opening be rectangular-shaped. Also, when the shape of the openings is a rectangular shape, as shown in FIG. 3, the openings may have notched sections.

The width of the opening may be appropriately selected depending on the use or the like of the color filter produced. However, when the openings have a rectangular shape, and as shown in FIG. 3, the shorter side “u1” is taken as the width of the opening, the width of the opening is preferably set to the range of 100 μm to 480 μm, more preferably to the range of 120 μm to 350 μm, and particularly preferably to the range of 145 μm to 250 μm.

On the other hand, when the opening has a rectangular shape, and as shown in FIG. 3, the longer side “u2” is taken as the width of the opening, the width of the opening is preferably set to the range of 130 μm to 600 μm, more preferably to the range of 150 μm to 520 μm, and particularly preferably to the range of 170 μm to 450 μm. It is because if the width of the opening is less than the range mentioned above, or the width is larger than the range mentioned above, there is a possibility that it may be difficult to produce a color filter that can achieve satisfactory image display, even in the case of using the method for producing a color filter of the present embodiment.

The film thickness of the light shielding part is not particularly limited as long as it is a film thickness with which the openings can be compartmentalized and a coloring layer having a desired film thickness can be formed by using an inkjet method. However, in the case of a light shielding part in which the film thickness of the light shielding part does not undergo shrinkage as a result of the baking treatment process that will be described later, the width is preferably in the range of 1.0 μm to 3.5 μm, more preferably in the range of 1.5 μm to 3.0 μm, and particularly preferably in the range of 2.0 μm to 2.5 μm. It is because if the film thickness of the light shielding part is less than the range mentioned above, there is a possibility that it may be difficult to form a coloring layer by using an inkjet method, and if the film thickness of the light shielding part is greater than the range mentioned above, there is a possibility that it may be difficult to form the color filter into a thin film.

Incidentally, when the light shielding part is a light shielding part in which the film thickness of the light shielding part undergoes shrinkage as a result of the baking treatment process that will be described below, it is preferable that the film thickness of the light shielding part before the baking treatment process be in the value range described above.

Such a light shielding part is not particularly limited as long as it has desired light shielding properties, but specifically, a light shielding part composed of a light shielding material and a resin is used.

Regarding the light shielding material, a material that is used in a resin-made light shielding part of a general color filter can be used. Examples of such a light shielding material include carbon fine particles, and light shielding particles of metal oxides, inorganic pigments, organic pigments and the like.

Furthermore, examples of the resin that can be used include an ethylene-vinyl acetate copolymer, an ethylene-vinyl chloride copolymer, an ethylene-vinyl copolymer, polystyrene, an acrylonitrile-styrene copolymer, an ABS resin, a polymethacrylic acid resin, an ethylene-methacrylic acid resin, a polyvinyl chloride resin, chlorinated vinyl chloride, polyvinyl alcohol, cellulose acetate propionate, cellulose acetate butyrate, nylon 6, nylon 66, nylon 12, polyethylene terephthalate, polybutylene terephthalate, polycarbonate, polyvinyl acetal, polyether ether ketone, polyether sulfone, polyphenylene sulfide, polyallylate, polyvinyl butyral, an epoxy resin, a phenoxy resin, a polyimide resin, a polyamideimide resin, a polyamic acid resin, a polyether imide resin, a phenolic resin, and a urea resin.

Regarding the method for forming the light shielding part, there are no particular limitations as long as the method is a method capable of forming a light shielding part in which the openings are arranged in a desired pattern. Examples thereof include a photolithography method using a resin composition containing light shielding particles, and a heat transfer method using the resin composition described above. As a specific method for forming such a light shielding part, the same method as the method for forming a light shielding part that is generally used in color filters can be used, and therefore, further detailed explanation will not be repeated here.

(iii) Means for Liquid Repellency

It is preferable that the light shielding part be made liquid-repellent. It is because thereby, when pre-drying coloring layers are formed by applying coloring layer-forming coating liquids on a black matrix substrate by an inkjet method, color mixing between adjacent pre-drying coloring layers can be prevented from occurring.

The means for imparting liquid repellency in the present process is not particularly limited as long as it is a means capable of making the light shielding part on the black matrix substrate liquid-repellent. For example, a method of forming a liquid-repellent layer patternwise by a photolithography method or the like such that a liquid-repellent layer having liquid repellency is formed only on the light shielding part, or a method of making only the light shielding part liquid-repellent by performing a plasma treatment by using a metal mask or the like may also be used.

According to the present embodiment, since the light shielding part can be made liquid-repellent easily with high accuracy, it is preferable to carry out a fluorine plasma process of making the light shielding part liquid-repellent by a fluorine plasma treatment, which is a plasma treatment using fluorine as a feed gas. It is because this fluorine plasma treatment can selectively attach fluorine to organic materials. In regard to such a fluorine plasma treatment, examples of the fluorine compound that may be used in the feed gas include CF₄, SF₆, CHF₃, C₂F₆, C₃H₈, and C₅F₈.

Furthermore, the feed gas may also be a mixture of the fluorine gas with another gas. Examples of the other gas include nitrogen, oxygen, argon and helium, but among them, nitrogen is preferably used. Furthermore, when nitrogen is used as the other gas, the mixing ratio of nitrogen is preferably 50% or more.

Furthermore, regarding the method of conducting plasma irradiation, there are no particular limitations as long as the method is a method capable of enhancing the liquid repellency of the light shielding part, and for example, the light shielding part may be subjected to plasma irradiation under reduced pressure, or may be subjected to plasma irradiation at atmospheric pressure. Among others, in the present process, it is particularly preferable to carry out plasma irradiation at atmospheric pressure. It is because thereby, apparatuses for pressure reduction and the like are not necessary, and it is advantageous in terms of cost or production efficiency. Incidentally, the presence of fluorine in the light shielding part or the like after the plasma irradiation has been performed can be confirmed by measuring the proportion of fluorine element in all the elements detected from the surface of the light shielding part in an analysis using an X-ray photoelectron spectrometer (XPS: for example, ESCALAB 220i-XL™ manufactured by V.G. Scientific, Ltd). Incidentally, the term “liquid repellency” means that the contact angle with the coloring layer-forming coating liquid that will be described below is large.

Specifically, it is desirable that the contact angle of the surface of the light shielding part with the coloring layer-forming coating liquid be larger than the contact angle of the substrate surface. Among them, in the present process, it is preferable that the contact angle of the surface of the light shielding part with a liquid of 40 mN/m be about 10° or greater; it is particularly preferable that the contact angle with a liquid having a surface tension of 30 mN/m be about 10° or greater; and it is more preferable that the contact angle with a liquid having a surface tension of 20 mN/m be about 10° or greater. Also, it is preferable that the contact angle with pure water be about 11° or greater.

(b) Coloring Layer-Forming Coating Liquid

Next, the coloring layer-forming coating liquid used in the present process will be explained.

The coloring layer-forming coating liquid used in the present process is not particularly limited as long as the coating liquid can be discharged by an inkjet apparatus. Usually, a red coloring layer-forming coating liquid, a green coloring layer-forming coating liquid, a blue coloring layer-forming coating liquid, and the like are used, but a coloring layer-forming coating liquid having a color other than the colors described above can also be used.

Regarding the coloring layer-forming coating liquid, usually a coating liquid containing a solvent, a coloring agent, a curing component and the like is used.

Regarding the solvent, a single solvent may be used, or a mixed solvent obtained by mixing two or more kinds of solvents may also be used.

The solvent is not particularly limited as long as the solvent can dissolve the coloring agent and the curing component contained in the ink to desired concentrations.

Here, in the present embodiment, the boiling point of the solvent is not particularly limited as long as it is a boiling point at which in the reduced-pressure drying treatment process that will be described below, the pre-drying coloring layer can be subjected to a reduced-pressure drying treatment such that the film thickness of the edges of the post-drying coloring layers is not smaller than the film thickness of the light shielding part. However, usually, a solvent which is capable of performing the prebaking treatment that will be described below in a short time is selected. Specifically, the boiling point of such a solvent is preferably in the range of 150° C. to 300° C., more preferably in the range of 180° C. to 280° C., and particularly preferably in the range of 200° C. to 250° C. It is because if the boiling point of the solvent is less than the range mentioned above, the treatment time for the prebaking treatment that will be described below becomes long, and a solvent having a boiling point that exceeds the aforementioned range is usually not put to use.

When the boiling point of the solvent is considered, it is preferable to use a substance such as diethylene glycol monobutyl ether acetate, diethylene glycol monoethyl ether acetate, dipropylene glycol monomethyl ether acetate, ethyl 3-ethoxypropionate, and dimethyl malonate as such a solvent.

The coloring agent is not particularly limited as long as it can absorb light having a desired wavelength. Such a coloring agent may be a dye-based material, or may be a pigment-based material. Specific examples of such a coloring agent are the same as those of the coloring agents used in general color filters, and therefore, further detailed explanation will not be repeated here.

The curing component is a component for curing the coloring agent when a coloring layer is formed, and usually, a crosslinkable monomer or the like is used. Examples of such a curing component include acrylic resins having substituents such as a hydroxyl group, a carboxyl group, an alkoxy group, an epoxy group, and an amide group; a silicone resin, an epoxy resin, and cellulose derivatives such as hydroxypropyl cellulose, hydroxyethyl cellulose, methyl cellulose and carboxymethyl cellulose, and modification products thereof; and vinyl-based polymers such as polyvinylpyrrolidone, polyvinyl alcohol, and polyvinyl acetal.

Furthermore, two or more kinds of such curing components may also be used in the present process.

Also, regarding the coloring layer-forming coating liquid used in the present process, necessary components can be appropriately selected and added in addition to the solvent, coloring agent and curing component described above. Examples of such components include a reaction initiator and a surfactant.

In regard to the solid component concentration in the coloring layer-forming coating liquid, since the solid component can be set to be similar to the solid component concentration in a coloring layer-forming coating liquid used at the time of forming a coloring layer using a general inkjet method, further explanation will not be repeated here. Incidentally, the solid component concentration represents the concentration of components other than the solvent in a coloring layer-forming coating liquid.

The viscosity of the coloring layer-forming coating liquid is not particularly limited as long as it is a viscosity capable of forming a pre-drying coloring layer having a predetermined thickness at the openings on the black matrix substrate by using an inkjet method, and the same viscosity as the viscosity of a coloring layer-forming coating liquid used in a general method for producing a color filter by using an inkjet method can be employed. Thus, further explanation will not be repeated here.

The surface tension of the coloring layer-forming coating liquid is not particularly limited as long as it is a surface tension capable of forming a pre-drying coloring layer having a predetermined film thickness on the black matrix substrate by using an inkjet method, and the same surface tension as the surface tension of a coloring layer-forming coating liquid used in a general method for producing a color filter by using an inkjet method can be employed. Therefore, further explanation will not be repeated here.

(c) Pre-Drying Coloring Layer

The average film thickness of the pre-drying coloring layer formed in the present step may be appropriately selected and determined depending on the use of the color filter produced by the production method of the present embodiment.

The average film thickness of the pre-drying coloring layer is not particularly limited as long as it is a film thickness capable of making the film thickness of the edges of the post-drying coloring layers obtained after a reduced pressure drying treatment process that will be described below, not smaller than the film thickness of the light shielding part. However, the thickness is preferably 4.7 μm or greater, more preferably 7.6 μm or greater, and particularly preferably 8.9 μm or greater. It is because if the average film thickness of the pre-drying coloring layer is less than the range mentioned above, there is a possibility that the maximum film thickness of the edges of the post-drying coloring layer obtained after the reduced-pressure drying treatment process that will be described below may become smaller than the film thickness of the light shielding part. Furthermore, the upper limit of the average film thickness of the pre-drying coloring layer may be appropriately selected depending on factors such as the size of the openings where the pre-drying coloring layers are formed, the coloring layer-forming coating liquid used, or the like; however, the upper limit of the film thickness is set to a film thickness at which the pre-drying coloring layer formed at the openings does not break down.

Incidentally, the “average film thickness of the pre-drying coloring layer” refers to a value obtained by dividing the coating amount of the coloring layer-forming coating liquid applied at an opening, by the area of the opening.

The method for forming the pre-drying coloring layer is not particularly limited as long as it is a forming method using an inkjet method.

The inkjet method used in the present process may be any method capable of accurately discharging the coloring layer-forming coating liquid to the opening, and usually, an inkjet head equipped with a plurality of nozzles that can apply the coloring layer-forming coating liquid is used.

Regarding the discharge method by which the inkjet head used in the present process discharges the coloring layer-forming coating liquid, there are no particular limitations as long as it is a method capable of discharging a predetermined amount of the coloring layer-forming coating liquid. Examples of such a discharge method include a method of continuously discharging a charged coloring layer-forming coating liquid, and controlling the amount of discharge by a magnetic field; a method of intermittently discharging a coloring layer-forming coating liquid by using a piezoelectric element; and a method of heating a coloring layer-forming coating liquid, and intermittently discharging the coating liquid by utilizing the phenomenon of foaming of the coating liquid. Among them, in the present process, a method of intermittently discharging a coloring layer-forming coating liquid by using a piezoelectric element is preferably used as the discharge method. It is because such a discharging method can control the discharge amount, which is a very small amount, with relatively high accuracy.

(2) Reduced-Pressure Drying Treatment Process

The present process is a process for forming a color filter substrate having post-drying coloring layers formed thereon, by subjecting the pre-drying coloring layers to a reduced-pressure drying treatment, and is a process in which the pre-drying coloring layers are subjected to a reduced-pressure drying treatment such that the film thickness of the edges of the post-drying coloring layers is not smaller than the film thickness of the light shielding part.

Incidentally, according to the present embodiment, the “color filter substrate” refers to a black matrix substrate having formed thereon post-drying coloring layers that have been subjected to a reduced-pressure drying treatment, but in the present process, black matrix substrates that are prior to the reduced-pressure drying treatment or in the middle of the reduced-pressure drying treatment may also be referred to as color filter substrates.

Hereinafter, the conditions for the reduced-pressure drying treatment, and the reduced-pressure drying treatment apparatus that is used in the reduced-pressure drying treatment will be respectively described.

(a) Conditions for Reduced-Pressure Drying Treatment

In the present process, there are no particular limitations as long as the pre-drying coloring layers can be subjected to a reduced-pressure drying treatment such that the film thickness of the edges of the post-drying coloring layers is not smaller than the film thickness of the light shielding part. More specifically, the pre-drying coloring layers are subjected to a reduced-pressure drying treatment such that the film thickness difference between the film thickness of the edges of the post-drying coloring layers and the film thickness of the light shielding part is 0.1 μm or less, preferably 0.05 μm or less, and particularly preferably 0 μm. It is because if the film thickness difference exceeds the range mentioned above, it is difficult to impart desired flatness to the coloring layers that are formed.

Furthermore, in the present process, the pre-drying coloring layers are subjected to a reduced-pressure drying treatment such that the ratio of the maximum film thickness of the post-drying coloring layer and the width of the opening is in the range described above. Incidentally, as described above, the ratio of the maximum film thickness of the post-drying coloring layer and the width of the opening in the present invention is a value which satisfies both the values calculated by using the widths “u1” and “u2” of the opening as shown in FIG. 3.

The maximum film thickness of the post-drying coloring layers that are formed in the present process is not particularly limited as long as it is a film thickness which makes the film thickness of the edges of the post-drying coloring layers not smaller than the film thickness of the light shielding part. Specifically, in the case where the width of the openings of the light shielding part is in the value range mentioned above, the maximum film thickness is preferably adjusted in the range of 4.7 μm to 22.7 μm, and more preferably in the range of 4.7 μm to 17.7 μm. It is because if the maximum film thickness of the post-drying coloring layers is less than the range mentioned above, there is a possibility that the film thickness of the edges of the post-drying coloring layer may become smaller than the film thickness of the light shielding part, and therefore, there is a possibility that it may become difficult to impart desired flatness to the coloring layers that are formed.

Furthermore, in the present process, the upper limit of the maximum film thickness of the post-drying coloring layers is not particularly limited as long as it is a film thickness at which bumping of the solvent in the post-drying coloring layer does not occur during the prebaking treatment that will be described below. However, in the method for producing a color filter of the present embodiment, since it is preferable that the treatment time of the prebaking treatment be a short time, it is preferable that the maximum film thickness of the post-drying coloring layer do not exceed the range mentioned above.

The treatment temperature of the reduced-pressure drying treatment in the present process is not particularly limited as long as it is a temperature at which the pre-drying coloring layers can be subjected to a reduced-pressure drying treatment such that the film thickness of the edges of the post-drying coloring layers obtained after a reduced-pressure drying treatment is not smaller than the film thickness of the light shielding part. However, if the temperature is low, since the reduced-pressure drying treatment takes time, there is a risk that the production efficiency may decrease. If the temperature is high, solvent removal occurs at one time, and it is not preferable. Therefore, a preferred treatment temperature for the present process is preferably in the range of 30° C. to 60° C., more preferably in the range of 35° C. to 55° C., and particularly preferably in the range of 40° C. to 50° C.

The treatment time of the reduced-pressure drying treatment is appropriately determined depending on factors such as the size of the color filter that is produced by the production method of the present embodiment.

The method for determining the conditions for the reduced-pressure drying treatment used in the present process is not particularly limited, as long as it is a method capable of determining the conditions to be conditions under which the pre-drying coloring layers can be subjected to a reduced-pressure drying treatment such that the film thickness of the edges of the post-drying coloring layers that are formed by the present process is not smaller than the film thickness of the light shielding part. For example, a method in which various conditions under which the film thickness difference between the film thickness of the edges of the post-drying coloring layers and the film thickness of the light shielding part satisfies the relationship described above, by forming pre-drying coloring layers in advance on a black matrix substrate for design applications, and subjecting these layers to a reduced-pressure drying treatment, are established and these conditions are used in the present process, can be suitably used.

(b) Reduced-Pressure Drying Treatment Apparatus

Next, the reduced-pressure drying treatment apparatus that is used in the present process will be explained.

Regarding the reduced-pressure drying treatment apparatus used in the present process, apparatuses that are generally used in the production of color filters can be used.

Specifically, an apparatus having a heating means that heats the color filter, a chamber that accommodates the heating unit, and a pressure reducing means that reduces the pressure inside the chamber to a desired pressure, may be used.

(i) Heating Means

The heating means may be any means capable of heating the color filter substrate to a desired temperature.

Examples of such a heating means include a hot plate, an electrically heated wire, a lamp, and an infrared emitting apparatus. In the present embodiment, among them, the heating means is preferably a hot plate. It is because since the hot plate is heated as a whole, there are no inconveniences that there are no particular sites with lower temperatures, such as those present in other heating means; volatilized solvent is rapidly cooled at those sites, causing dew condensation, and the dews fall dropwise on the color filer substrate and cause breakdown of the coloring layers formed at the openings, causing color mixing. Furthermore, it is because it is easy to heat the color filter substrate uniformly from a plan view, and the coloring layers formed by drying the pre-drying coloring layers have excellent flatness.

The heating capacity of the heating means that is used in the reduced-pressure drying treatment apparatus is desirably such that the color filter substrate can be heated to a desired temperature. Specifically, it is preferable that the color filter substrate can be heated to the range of 30° C. to 60° C., more preferably to the range of 35° C. to 55° C., and particularly preferably to the range of 40° C. to 50° C. It is because when the color filter substrate is heated to the range mentioned above, the solvent can be efficiently removed. Incidentally, the foregoing temperature does not represent the temperature of the color filter substrate itself, but represents the treatment temperature obtainable by the heating means.

Furthermore, the disposition of the heating means with respect to the color filter substrate may be such that the heating means may be disposed below the color filter substrate so that the color filter substrate is heated from below, or the heating means may be disposed above the color filter substrate so that the color filter substrate is heated from above. In the present embodiment, above all, it is preferable that the heating means be disposed below and above the color filter substrate so that the color filter substrate is heated from both the upper and lower directions. As described above, it is because there are no inconveniences such as breakdown of the coloring layers and color mixing, and since the color filter substrate can be heated uniformly from a plan view, coloring layers having excellent flatness can be obtained.

(ii) Chamber

The chamber may be any chamber which can accommodate the heating means inside the chamber, and has high sealability at the time of drying.

The shape and size of the chamber may be appropriately set depending on factors such as the size of the color filter substrate to be dried.

(iii) Pressure Reducing Means

The pressure reducing means in the reduced-pressure drying treatment apparatus is intended to reduce the pressure inside the chamber. Regarding such a pressure reducing means, a general pressure reducing apparatus such as a vacuum pump can be used.

The pressure reduction capacity of the pressure reducing means used in the reduced-pressure drying treatment apparatus is desirably such that the pressure inside the chamber can be adjusted to a pressure at which the color filter substrate can be dried at a desired rate. Specifically, it is preferable that the steady pressure under reduced pressure in the chamber can be set to the range of less than 4 Pa, and more preferably to the range of less than 1 Pa. It is because when the pressure is in the range mentioned above, the solvent can be easily removed.

Incidentally, the steady pressure under reduced pressure refers to the equilibrium pressure that is reached when reduced-pressure drying is carried out in a state in which the chamber of the reduced-pressure drying apparatus is emptied, that is, in a state in which a color filter substrate or any condensed solvent is absent. Furthermore, the equilibrium pressure refers to a pressure that is in steady state, and more specifically, to an average pressure obtainable in a state in which when the average pressure obtained for 90 seconds is designated as the reference, the pressure values measured for 90 seconds are included in the range of ±10% of the average pressure.

(3) Baking Treatment Process

The present process is a process in which the color filter substrate is subjected to a prebaking treatment and subsequently to a post-baking treatment, and thus a color filter having coloring layers formed thereon is obtained. Hereinafter, the prebaking process and the post-baking process in the present process will be respectively described.

(a) Prebaking Treatment

The prebaking treatment according to the present process is a treatment of removing the solvent that remains in the post-drying coloring layers, and also achieving flattening of the coloring layers as described above.

Here, when it is said that bumping of the solvent in the post-drying coloring layers does not occur, it is implied that in the case where the boiling point of the solvent used in the coloring layer-forming coating liquids for the color filter is in the range of 150° C. to 300° C., when a prebaking treatment is carried out at a temperature in the range of 70° C. to 110° C. as the treatment temperature of the prebaking treatment, bumping of the solvent in the post-drying coloring layers and color mixing of adjacent coloring layers do not occur. The temperature for the prebaking treatment is more preferably in the range of 80° C. to 100° C. It is because if the treatment temperature is lower than the temperature range mentioned above, due to insufficient removal of the solvent in the coloring layers, bumping and color mixing may easily occur in the post-baking treatment process; and if the temperature is higher than the treatment temperature described above, color mixing caused by bumping in the prebaking treatment process may easily occur as a result of rapid solvent volatilization inside the coloring layers, and the shape of the coloring layers tends to deteriorate.

Furthermore, the treatment time for the prebaking treatment may be appropriately selected depending on factors such as the size of the color filter substrate, but the treatment time is preferably in the range of 5 minutes to 60 minutes.

According to the present embodiment, within the ranges of temperature and treatment time for the prebaking treatment described above, it is preferable to apply the prebaking treatment at a lower temperature for a longer time. It is because when the prebaking treatment is applied at a low temperature over a long time period, the coloring layers that are thus formed can have improved flatness.

The reason for this is not clearly understood, but it is speculated as follows.

The prebaking treatment is considered to be intended to achieve flattening of a post-drying coloring layer formed at an opening, by fluidizing the post-drying coloring layer from the center of the post-drying coloring layer where the film thickness is large, to the edges of the post-drying coloring layer where the film thickness is small. Therefore, it is speculated that as the treatment temperature is lowered and the treatment time is lengthened in the prebaking treatment, the time for the post-drying coloring layer to be fluidized can be lengthened, and accordingly, flatness of the coloring layer that is formed can be enhanced.

Such a prebaking treatment is usually carried out by using a clean oven or the like.

(b) Post-Baking Treatment

The post-baking treatment according to the present process is carried out in order to cure a coloring layer from which the solvent has been completely removed by the prebaking treatment, and flattening is also achieved to a certain extent in this treatment.

The post-baking treatment according to the present process is similar to conventional post-baking treatments, and specifically, the treatment is carried out preferably at a temperature in the range of 160° C. to 250° C., and particularly preferably in the range of 200° C. to 240° C. Furthermore, the treatment time is preferably in the range of 10 minutes to 120 minutes, and particularly preferably in the range of 20 minutes to 80 minutes.

Such a post-baking treatment is also usually carried out by using a clean oven or the like.

The average film thickness of the coloring layer that is formed in the present process may be appropriately selected depending on the use of the color filter that is produced by the production method of the present embodiment, but the average film thickness is preferably in the range of 1.5 μm to 3.0 μm, and more preferably in the range of 1.8 μm to 2.7 μm. It is because if the film thickness of the coloring layer is less than the range described above, even in the case of using the method for producing a color filter of the present embodiment, it is difficult to form a coloring layer with high flatness, and if the film thickness of the coloring layer is greater than the range described above, it is difficult to form the color filter into a thin film.

Incidentally, regarding the average film thickness of the coloring layer, the values measured by using a light interference type three-dimensional non-contact surface profilometer (for example, trade name: MICROMAP 557N manufactured by US Micromap Corp.) are used.

(4) Other Processes

According to the present embodiment, other processes may also be carried out as necessary. Specifically, a water-washing process may be provided before the liquid repellency treatment process. Also, an ITO film forming process for forming a transparent electrode may also be provided after the baking process. Furthermore, a process for forming a protective layer that is formed on the coloring layers, or a process for forming pillar-shaped spacers may also be provided.

(5) Method for Producing Color Filter

The color filter that is produced by the method for producing a color filter of the present embodiment is not particularly limited as long as the color filter has a coloring layer of at least one color formed thereon by the various processes described above, and all of the coloring layers carried by the color filter may also be formed by the various processes described above.

Furthermore, the method for producing a color filter of the present embodiment can also be used when a color filter having a semi-multi-gap structure in which, for example, in a color filter having a red coloring layer, a green coloring layer and a blue coloring layer formed thereon, the film thicknesses of the red coloring layer and the green coloring layer is smaller than the film thickness of the blue coloring layer; or a color filter having a multi-gap structure in which the film thicknesses of the red coloring layer, green coloring layer and blue coloring layer are all different.

Here, when a color filter which includes coloring layers of a plurality of colors having different film thicknesses is produced, in the case of using the method for producing a color filter of the present embodiment, coloring layers of a plurality of colors having different film thicknesses can be simultaneously formed by a single layer-forming process. Therefore, it is effective because the production efficiency of the color filter can be increased to a large extent.

Hereinafter, an embodiment in which the method for producing a color filter of the present embodiment is applied to the case of producing a color filter which includes coloring layers of a plurality of colors having different film thicknesses (hereinafter, referred to as embodiment A), will be described.

### Embodiment A

The method for producing a color filter of the present embodiment is a method for producing a color filter which comprises a black matrix substrate having a transparent substrate and a light shielding part that is formed on the transparent substrate and has openings, and coloring layers of a plurality of colors formed at the openings on the black matrix substrate, with the coloring layers of a plurality of colors being formed such that the film thickness of a coloring layer of at least one color is smaller than the film thicknesses of the coloring layers of other colors, the method comprising steps of: an inkjet step of applying coloring layer-forming coating liquids by an inkjet method on the openings of the black matrix substrate and thereby forming pre-drying coloring layers of a plurality of colors; a reduced-pressure drying treatment step of subjecting the pre-drying coloring layers of a plurality of colors to the reduced-pressure drying treatment and thereby forming a color filter substrate having post-drying coloring layers of a plurality of colors formed thereon; and a baking treatment step of subjecting the color filter substrate to a prebaking treatment and subsequently to a post-baking treatment, and obtaining a color filter having the coloring layers of a plurality of colors formed thereon, wherein in the reduced-pressure drying treatment step, the pre-drying coloring layers of a plurality of colors are subjected to a reduced-pressure drying treatment such that the film thickness of the edge of a post-drying coloring layer having the smallest film thickness is not smaller than the film thickness of the light shielding part.

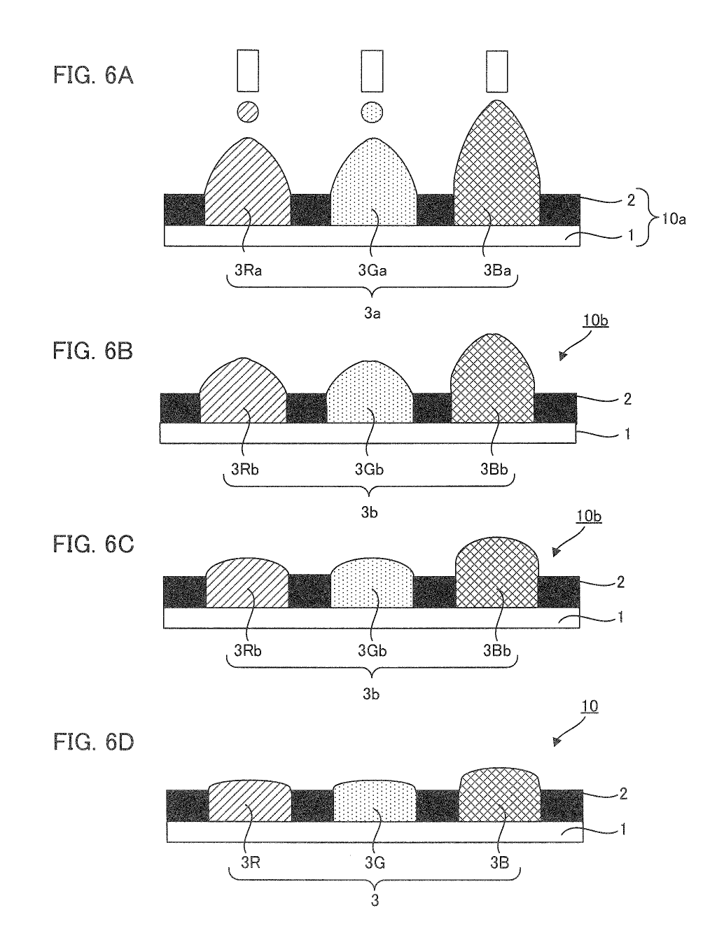

The method for producing a color filter of the present embodiment will be described by using the drawings. FIGS. 6A to 6D are a process diagram illustrating an example of the method for producing a color filter of the present embodiment. Furthermore, FIGS. 6A to 6D illustrate an example of producing a color filter which has a semi-multi-gap structure in which the red coloring layer and the green coloring layer are formed to be smaller than the blue coloring layer.

In the method for producing a color filter of the present embodiment, first, an inkjet process (FIG. 6A) of applying coloring layer-forming coating liquids by an inkjet method at the openings of a black matrix substrate 10a including a transparent substrate 1 and a light shielding part 2, and thereby forming pre-drying coloring layers of a plurality of colors 3a (in FIG. 6A, a red pre-drying coloring layer 3Ra, a green pre-drying coloring layer 3Ga, and a blue pre-drying coloring layer 3Ba), is carried out. Next, a reduced-pressure drying treatment process (FIG. 6B) of subjecting the pre-drying coloring layers of a plurality of colors 3a to a reduced-pressure drying treatment, and forming a color filter substrate 10b having post-drying coloring layers of a plurality of colors 3b (in FIG. 6B, a red post-drying coloring layer 3Rb, a green post-drying coloring layer 3Gb and a blue post-drying coloring layer 3Bb) formed thereon, is carried out. Next, a baking treatment process (FIGS. 6C to 6D) of subjecting the color filter substrate 10b to a prebaking treatment (FIG. 6C) and subsequently to a post-baking treatment, and obtaining a color filter 10 having coloring layers of a plurality of colors 3 (in FIG. 6D, a red post-drying coloring layer 3R, a green post-drying coloring layer 3G, and a blue post-drying coloring layer 3B) formed thereon, is carried out. Furthermore, in the reduced-pressure drying treatment process, as shown in FIG. 6B, the red pre-drying coloring layer 3Ra and the green pre-drying coloring layer 3Ga are subjected to a reduced-pressure drying treatment such that the film thicknesses of the red post-drying coloring layer 3Rb and a green post-drying coloring layer 3Gb are not smaller than the film thickness of the light shielding part 2.

According to the present invention, the content of the solvent in a post-drying coloring layer having the smallest film thickness among the coloring layers of a plurality of colors can be adjusted to the minimum content with which desired flatness can be imparted to the coloring layers that are formed, and the prebaking treatment can be carried out in a short time. Therefore, the coloring layers having other film thicknesses can be formed by applying coloring layer-forming coating liquids into thick films so that there are obtained post-drying coloring layers having a film thickness of the extent that bumping of the solvent in the post-drying coloring layers does not occur under the conditions of the prebaking treatment. Even in the case of simultaneously forming coloring layers of a plurality of colors having different film thicknesses, desired flatness can be imparted to the respective coloring layers, and color mixing of the coloring layers of various colors can be prevented from occurring. Accordingly, it is not necessary to form a plurality of coloring layers having different film thicknesses respectively in separate forming processes, and a plurality of coloring layers can be formed in a single layer-forming process. Therefore, the production efficiency can be increased to a large extent.

Here, in the present embodiment, the coloring layer having the smallest film thickness can be formed by applying the method for producing a color filter described above. Furthermore, according to the present embodiment, in an environment that is the same as that for the reduced-pressure drying treatment step and the baking treatment step that are carried out when the coloring layer having the smallest film thickness is formed, it is necessary for the coloring layers of other film thicknesses to have desired flatness, and to prevent color mixing from occurring in the coloring layers of various colors. Hereinafter, the method for forming coloring layers of other film thicknesses will be explained.

Incidentally, regarding the layer-forming conditions that are not described below, the same layer-forming conditions as those used in the method for forming the coloring layer having the smallest film thickness as described above can be employed, and therefore, further descriptions will not be repeated here.

The average film thickness of the pre-drying coloring layers formed in the inkjet process is not particularly limited as long as the maximum film thickness of the post-drying coloring layers obtained after the reduced-pressure drying treatment process can be adjusted to a film thickness at which bumping of the solvent in the post-drying coloring layers does not occur during the prebaking treatment, and the average film thickness is preferably 7.7 μm or greater, and particularly preferably 10.0 μm or greater. It is because if the film thickness of the pre-drying coloring layers is less than the range mentioned above, there is a possibility that it may be difficult to form a desired film thickness difference between the coloring layers that are formed and the coloring layer having the smallest film thickness as described above, and because if the film thickness of the pre-drying coloring layers is greater than the range mentioned above, there is a possibility that it may be difficult to form coloring layers.

The maximum film thickness of the post-drying coloring layers that are formed in the reduced-pressure drying treatment process according to the present embodiment is not particularly limited, as long as the maximum film thickness can be adjusted to a film thickness at which bumping of the solvent in the post-drying coloring layers during the prebaking treatment, and color mixing between the coloring layers do not occur. However, specifically, the maximum film thickness is preferably in the range of 7.7 μm to 22.7 μm. It is because if the film thickness of the post-drying coloring layers is less than the range mentioned above, there is a possibility that it may be difficult to form a desired film thickness difference between the coloring layers that are formed and the coloring layer having the smallest film thickness as described above, and because if the film thickness of the post-drying coloring layers is greater than the range mentioned above, since the content of the solvent in the post-drying coloring layers is large, there is a possibility that color mixing between the coloring layers at the time of the prebaking treatment may occur.

The color filter produced by the production method of embodiment A is not particularly limited as long as the color filter has coloring layers of a plurality of colors having different film thicknesses, but the color filter is preferably a color filter having a semi-multi-gap structure in which a red coloring layer and a green coloring layer are formed such that the film thicknesses thereof are smaller than the film thickness of the blue coloring layer. It is because when used in a liquid crystal display apparatus, the color filter of the configuration described above can have higher luminance for the blue pixel region, and therefore, satisfactory image display can be carried out.

2. Method for Producing Color Filter of Second Embodiment

Next, the second embodiment of the method for producing a color filter of the present invention will be explained.

The method for producing a color filter of the present embodiment is a production method in which in the reduced-pressure drying treatment step, the pre-drying coloring layer is subjected to a reduced-pressure drying treatment such that the ratio of the maximum film thickness of the post-drying coloring layer and the width of the opening is in the range of 7.8×10⁻³ to 2.3×10⁻¹, when the width of the opening is taken as 1.

Here, as discussed in the section of “1. Method for producing color filter of first embodiment”, the film thickness of the edges of the post-drying coloring layer is correlated with the ratio between the maximum film thickness of the post-drying coloring layer and the width of the opening. Thus, in the present embodiment, the conditions for the reduced-pressure drying treatment under which the content of the solvent in the post-drying coloring layer can be adjusted to the minimum content with which desired flatness can be imparted to the coloring layers that are formed, are expressed by using the ratio between the maximum film thickness of the post-drying coloring layers and the width of the openings.

Incidentally, since the various processes in the method for producing a color filter of the present embodiment can be carried out similarly to the processes of the method for producing a color filter of the first embodiment described above, further explanation will not be given here.

The method for producing a color filter of the present embodiment can also be suitably used when a color filter having coloring layers of a plurality of colors with different film thicknesses is produced, similarly to the method for producing a color filter of the first embodiment described above.

Hereinafter, an embodiment in which the method for producing a color filter of the present embodiment is applied to the case of producing a color filter having coloring layers of a plurality of colors with different film thicknesses (hereinafter, referred to embodiment B) will be described.

### Embodiment B

The method for producing a color filter of the present embodiment is a method for producing a color filter which comprises a black matrix substrate having a transparent substrate and a light shielding part that is formed on the transparent substrate and has openings, and coloring layers of a plurality of colors formed at the openings on the black matrix substrate, with the coloring layers of a plurality of colors being formed such that the film thickness of a coloring layer of at least one color is smaller than the film thicknesses of the coloring layers of other colors, the method comprising steps of: an inkjet step of applying coloring layer-forming coating liquids by an inkjet method on the openings of the black matrix substrate and thereby forming pre-drying coloring layers of a plurality of colors; a reduced-pressure drying treatment step of subjecting the pre-drying coloring layers of a plurality of colors to a reduced-pressure drying treatment and thereby forming a color filter substrate having post-drying coloring layers of a plurality of colors formed thereon; and a baking treatment step of subjecting the color filter substrate to a prebaking treatment and subsequently to a post-baking treatment, and obtaining a color filter having the coloring layers of a plurality of colors formed thereon, wherein in the reduced-pressure drying treatment step, the pre-drying coloring layers of a plurality of colors are subjected to the reduced-pressure drying treatment such that the ratio of the maximum film thickness of the post-drying coloring layer having the smallest film thickness and the width of the openings is in the range of 7.8×10⁻³ to 2.3×10⁻¹, when the width of the openings is taken as 1.

Here, also in the present embodiment, the coloring layer having the smallest film thickness can be formed by using the method for producing a color filter described above. Furthermore, in regard to the method for forming a coloring layer having a different film thickness, since the method can be carried out similarly to the method for forming a coloring layer other than the coloring layer having the smallest film thickness, which was described in the section for the method for producing a color filter of embodiment A, further explanation will not be given here.

Incidentally, in the present embodiment, it is preferable to produce a color filter having a semi-multi-gap structure in which the red coloring layer and the green coloring layer are formed such that the film thicknesses of these layers are smaller than the film thickness of the blue coloring layer. Furthermore, at that time, it is more preferable to subject the pre-drying coloring layers of a plurality of colors to a reduced-pressure drying treatment such that the ratio of the maximum film thickness of the post-drying coloring layer having the smallest film thickness and the width of the openings is in the range of 7.8×10⁻³ to 1.8×10⁻¹, when the width of the openings is taken as 1.

Incidentally, the value range described above can be calculated, for example, as follows.

When the film thickness of the light shielding part before shrinkage in advance to the baking treatment process is set to 2.7 μm, the width “u1” of the opening shown in FIG. 3 is set to the range of 100 μm to 480 μm, and the width “u2” of the opening is set to the range of 130 μm to 600 μm, and the maximum film thickness of the post-drying coloring layer after the reduced-pressure drying is set to +2 μm to +15 μm with respect to the film thickness of the light shielding part as a reference, the value range can be calculated.

The present invention is not intended to be limited to the embodiments described above. The above-described embodiments are for illustrative purposes, and any embodiment having substantially the same configuration as the technical idea described in the claims of the present invention and providing the same operating effect is included in the technical scope of the present invention.

### Examples

Hereinafter, the present invention will be specifically described by way of Examples and Comparative Examples.

I. Conditions for Reduced-Pressure Drying Treatment

1. Production of Black Matrix Substrate (BM Substrate)

(Formation of Light Shielding Part)

A light shielding part was formed on a glass substrate (horizontal length 2850 mm×longitudinal length 3050 mm×thickness 0.7 mm, manufactured by Corning Inc.) (transparent substrate) by using a photosensitive resin composition containing a light shielding black pigment by a photolithographic method, and eighteen screens each having a size of 40 inches were formed. In each of the screens, one pixel was formed at a pitch in the horizontal direction of 115 μm and a pitch in the longitudinal direction of 465 μm, with the dimension of the opening being 100 μm×450 μm and the line width of the light shielding section being 15 μm, and a pixel pattern (chip) was formed in which 5525 pixels were arranged in lines at a pitch of 115 μm in the horizontal direction, and 1070 pixels were arranged in lines at a pitch of 465 μm in the longitudinal direction. Furthermore, the thickness of the light shielding part was 2.7 μm when the shrinkage before the baking treatment process did not occur, and the thickness of the light shielding part finally obtainable when a color filter was produced was 2.4 μm as an average of 20 pixels. Also, the width of the opening was such that “u1” in FIG. 3 was 100 μm, and “u2” was 450 μm.

(Water Washing Process)

A cleaning apparatus which sprayed pure water by high pressure spray while conveying the transparent substrate having the light shielding part described above formed thereon was used, and an air knife was used after the water spray, to cause the water on the transparent substrate to be sprayed to flow.

(Water Repellency Treatment Process)

Next, the surface of the transparent substrate on the light shielding part side was subjected to an atmospheric pressure plasma treatment fed with fluorine gas, and thereby, the surface on the light shielding part side was made liquid-repellent, while the glass surface part was made lyophilic. The atmospheric pressure plasma treatment was carried out under the following conditions. In this manner, a BM substrate was produced. Furthermore, the contact angle of the substrate for forming a color filter thus obtained, with a liquid of 40 mN/m was 60° as an average of the values measured at 20 sites on the surface of the light shielding part, and the contact angle on the glass substrate was 10°. Incidentally, this contact angle was obtained as a result of making measurement (30 seconds after dropping liquid droplets from a microsyringe) by using a contact angle analyzer (Model CA-Z manufactured by Kyowa Interface Science Co., Ltd.).

<Conditions for Plasma Irradiation>
Feed gas: CF₄ . . . 17.1 L/min, N₂ . . . 97.3 L/min
Frequency: 29 Hz
Power supply output: 420 V-5a

2. Inkjet Process and Reduced-Pressure Drying Treatment Process

(Preparation of Coloring Layer-Forming Coating Liquids)

Coloring layer-forming coating liquids of red, green and blue colors were prepared by the following formulations.

<Red Coloring Layer-Forming Coating Liquid>
Pigment: R254/R242/Y150 . . . 7.04 parts by mass
Dispersing agent: AJISPER-Pb821™ (product of Ajinomoto Fine-Techno Co., Inc.) . . . 4.22 parts by mass
Main solvent: Diethylene glycol monobutyl ether acetate . . . 73.20 parts by mass
Sub-solvent: Ethyl 3-ethoxypropionate . . . 10.00 parts by mass
Binder: GMA acrylic resin . . . 5.54 parts by mass
Leveling agent: LHP-90™ (Kusumoto Chemicals, Ltd.) . . . 0.09 part by mass

The P/V ratio was 0.73, the solids concentration was 16.8%, and the viscosity was 9.8 CPS. Incidentally, the viscosity is a value measured at room temperature (23° C.) by using a falling ball viscometer.

<Green Coloring Layer-Forming Coating Liquid>
Pigment: G36/Y150/R254 . . . 8.11 parts by mass
Dispersing agent: AJISPER Pb821™ (product of Ajinomoto Fine-Techno Co., Ltd.) . . . 4.87 parts by mass
Main solvent: Diethylene glycol monobutyl ether acetate . . . 65.30 parts by mass
Sub-solvent: Ethyl 3-ethoxypropionate . . . 15.00 parts by mass
Binder: GMA acrylic resin . . . 6.72 parts by mass
Leveling agent: LHP-90™ (Kusumoto Chemicals, Ltd.) . . . 0.09 part by mass

The P/V ratio was 0.70, the solids concentration was 21.0%, and the viscosity was 9.8 CPS. Incidentally, the viscosity was a value measured at room temperature (23° C.) by using a falling ball viscometer.

<Blue Coloring Layer-Forming Coating Liquid>
Pigment: B156/V23 . . . 2.85 parts by mass
Dispersing agent: AJISPER-Pb821™ (product of Ajinomoto Fine-Techno Co., Inc.) . . . 1.71 parts by mass
Main solvent: Diethylene glycol monobutyl ether acetate . . . 69.00 parts by mass
Sub-solvent: Ethyl 3-ethoxypropionate . . . 10.00 parts by mass
Binder: GMA acrylic resin . . . 16.45 parts by mass
Leveling agent: LHP-90™ (Kusumoto Chemicals, Ltd.) . . . 0.06 part by mass

The P/V ratio was 0.20, the solids concentration was 21.0%, and the viscosity was 10.0 CPS. Incidentally, the viscosity was a value measured at room temperature (23° C.) by using a falling ball viscometer.

(Inkjet Process and Reduced-Pressure Drying Treatment Process)

As described in Examples 1 to 13 and Comparative Examples 1 to 6 below, coloring layer-forming coating liquids of various colors were discharged on the BM substrate by using an inkjet apparatus, and thus, pre-drying coloring layers were formed. A reduced-pressure drying treatment was carried out under the respective conditions for the reduced-pressure drying treatment by using a heating reduced-pressure drying apparatus using a hot plate. Incidentally, the coating amounts of the coloring layer-forming coating liquids of various colors shown below were coating amounts which resulted in a film thickness of the red coloring layer and the green coloring layer of 2.1 μm and a film thickness of the blue coloring layer of 2.4 μm, all as the film thicknesses of coloring layers obtained after a post-baking treatment.

Furthermore, the temperature for the reduced-pressure drying treatment was 40° C. in all cases.

### Example 1

A red pre-drying coloring layer was formed by using a red coloring layer-forming coating liquid, and the red pre-drying coloring layer was subjected to a reduced-pressure drying treatment until the height of the post-drying coloring layer after the reduced-pressure drying treatment would be a height of +2 μm with respect to the light shielding part (maximum film thickness: 4.7 μm). Thereby, a color filter substrate was obtained.

### Example 2

A color filter substrate was obtained in the same manner as in Example 1, except that the red pre-drying coloring layer was subjected to a reduced-pressure drying treatment until the height of the post-drying coloring layer after the reduced-pressure drying treatment would be a height of +6 μm with respect to the light shielding part (maximum film thickness: 8.7 μm).

### Example 3

A color filter substrate was obtained in the same manner as in Example 1, except that the red pre-drying coloring layer was subjected to a reduced-pressure drying treatment until the height of the post-drying coloring layer after the reduced-pressure drying treatment would be a height of +8 μm with respect to the light shielding part (maximum film thickness: 10.7 μm).

### Example 4

A color filter substrate was obtained in the same manner as in Example 1, except that the red pre-drying coloring layer was subjected to a reduced-pressure drying treatment until the height of the post-drying coloring layer after the reduced-pressure drying treatment would be a height of +15 μm with respect to the light shielding part (maximum film thickness: 17.7 μm).

### Example 5

A green pre-drying coloring layer was formed by using a green coloring layer-forming coating liquid, and the green pre-drying coloring layer was subjected to a reduced-pressure drying treatment until the height of the post-drying coloring layer after the reduced-pressure drying treatment would be a height of +2 μm with respect to the light shielding part (maximum film thickness: 4.7 μm). Thereby, a color filter substrate was obtained.

### Example 6

A color filter substrate was obtained in the same manner as in Example 5, except that the green pre-drying coloring layer was subjected to a reduced-pressure drying treatment until the height of the post-drying coloring layer after the reduced-pressure drying treatment would be a height of +6 μm with respect to the light shielding part (maximum film thickness: 8.7 μm).

### Example 7

A color filter substrate was obtained in the same manner as in Example 5, except that the green pre-drying coloring layer was subjected to a reduced-pressure drying treatment until the height of the post-drying coloring layer after the reduced-pressure drying treatment would be a height of +8 μm with respect to the light shielding part (maximum film thickness: 10.7 μm).

### Example 8

A color filter substrate was obtained in the same manner as in Example 5, except that the green pre-drying coloring layer was subjected to a reduced-pressure drying treatment until the height of the post-drying coloring layer after the reduced-pressure drying treatment would be a height of +15 μm with respect to the light shielding part (maximum film thickness: 17.7 μm).

### Example 9

A blue pre-drying coloring layer was formed by using a blue coloring layer-forming coating liquid, and the blue pre-drying coloring layer was subjected to a reduced-pressure drying treatment until the height of the blue post-drying coloring layer after the reduced-pressure drying treatment would be a height of +5 μm with respect to the light shielding part (maximum film thickness: 7.7 μm). Thereby, a color filter substrate was obtained.

### Example 10

A blue pre-drying coloring layer was formed by using a blue coloring layer-forming coating liquid, and the blue pre-drying coloring layer was subjected to a reduced-pressure drying treatment until the height of the blue post-drying coloring layer after the reduced-pressure drying treatment would be a height of +7 μm with respect to the light shielding part (maximum film thickness: 9.7 μm). Thereby, a color filter substrate was obtained.

### Example 11

A color filter substrate was obtained in the same manner as in Example 9, except that the blue pre-drying coloring layer was subjected to a reduced-pressure drying treatment until the height of the blue post-drying coloring layer after the reduced-pressure drying treatment would be a height of +12 with respect to the light shielding part (maximum film thickness: 14.7 μm).

### Example 12

A color filter substrate was obtained in the same manner as in Example 9, except that the blue pre-drying coloring layer was subjected to a reduced-pressure drying treatment until the height of the blue post-drying coloring layer after the reduced-pressure drying treatment would be a height of +15 μm with respect to the light shielding part (maximum film thickness: 17.7 μm).

### Example 13

A color filter substrate was obtained in the same manner as in Example 9, except that the blue pre-drying coloring layer was subjected to a reduced-pressure drying treatment until the height of the blue post-drying coloring layer after the reduced-pressure drying treatment would be a height of +20 μm with respect to the light shielding part (maximum film thickness: 22.7 μm).

Incidentally, in Examples 1 to 13, the film thickness of the edges of the pre-drying coloring layer did not become smaller than the film thickness of the light shielding part in all cases.

### Comparative Example 1

A color filter substrate was obtained in the same manner as in Example 1, except that the red pre-drying coloring layer was subjected to a reduced-pressure drying treatment until the height of the red post-drying coloring layer after the reduced-pressure drying treatment would be a height of −0.2 μm with respect to the light shielding part (maximum film thickness: 2.5 μm).

### Comparative Example 2

A color filter substrate was obtained in the same manner as in Example 5, except that the green pre-drying coloring layer was subjected to a reduced-pressure drying treatment until the height of the green post-drying coloring layer after the reduced-pressure drying treatment would be a height of −0.2 μm with respect to the light shielding part (maximum film thickness: 2.5 μm).

### Comparative Example 3

A color filter substrate was obtained in the same manner as in Example 9, except that the blue pre-drying coloring layer was subjected to a reduced-pressure drying treatment until the height of the blue post-drying coloring layer after the reduced-pressure drying treatment would be a height of +0.5 μm with respect to the light shielding part (maximum film thickness: 3.2 μm). Incidentally, the film thickness of the edges of the blue post-drying coloring layer became smaller than the film thickness of the light shielding part.

### Comparative Example 4

A color filter substrate was obtained in the same manner as in Example 1, except that the red pre-drying coloring layer was subjected to a reduced-pressure drying treatment until the height of the red post-drying coloring layer after the reduced-pressure drying treatment would be a height of +21 μm with respect to the light shielding part (maximum film thickness: 23.7 μm).

### Comparative Example 5

A color filter substrate was obtained in the same manner as in Example 5, except that the green pre-drying coloring layer was subjected to a reduced-pressure drying treatment until the height of the green post-drying coloring layer after the reduced-pressure drying treatment would be a height of +21 μm with respect to the light shielding part (maximum film thickness: 23.7 μm).

### Comparative Example 6

A color filter substrate was obtained in the same manner as in Example 9, except that the blue pre-drying coloring layer was subjected to a reduced-pressure drying treatment until the height of the blue post-drying coloring layer after the reduced-pressure drying treatment would be a height of +24 μm with respect to the light shielding part (maximum film thickness: 26.7 μm).

3. Baking Treatment Process

The substrates for color filter obtained in Examples 1 to 13 and Comparative Examples 1 to 6 were subjected to a prebaking treatment in a clean oven at 100° C. for 20 minutes, and then was subjected to a post-baking treatment in a clean oven at 230° C. for 40 minutes. Thus, a color filter was obtained respectively.

4. Evaluation

For the color filters obtained in Examples 1 to 13 and Comparative Examples 1 to 6, the presence or absence of breakdown and color mixing of the coloring layers, and the difference between the maximum film thickness and the minimum film thickness of the coloring layers were respectively investigated. The results are presented in Table 1. Incidentally, breakdown and color mixing means that the coloring layers of various colors undergo color mixing over the light shielding part. Furthermore, the difference between the maximum film thickness and the minimum film thickness of the coloring layers was measured by using a light interference type three-dimensional non-contact surface profilometer (for example, trade name: MICROMAP 557N manufactured by US Micromap Corp).

The results are presented in Table 1. Incidentally, in Table 1, “t” (μm) represents the maximum film thickness of the post-drying coloring layer, and t/u represents the ratio of the maximum film thickness of the post-drying coloring layer and the width of the opening (when the width of the opening is taken as 1).

TABLE 1

| | | | | | | Breakdown | |
|---|---|---|---|---|---|---|---|
| | | | | t/u | | and color | Film thickness |
| | Color | Height (μm) | t (μm) | t/u1 | t/u2 | mixing | difference (μm) |
| Example 1 | R | 2 | 4.7 | 4.7 × 10⁻² | 1.0 × 10⁻² | Absent | 0.54 |
| Example 2 | R | 6 | 8.7 | 8.7 × 10⁻² | 1.9 × 10⁻² | Absent | 0.50 |
| Example 3 | R | 8 | 10.7 | 1.1 × 10⁻¹ | 2.3 × 10⁻² | Absent | 0.49 |
| Example 4 | R | 15 | 17.7 | 1.8 × 10⁻¹ | 3.8 × 10⁻² | Absent | 0.47 |
| Example 5 | G | 2 | 4.7 | 4.7 × 10⁻² | 1.0 × 10⁻² | Absent | 0.52 |
| Example 6 | G | 6 | 8.7 | 8.7 × 10⁻² | 1.9 × 10⁻² | Absent | 0.51 |
| Example 7 | G | 8 | 10.7 | 1.1 × 10⁻¹ | 2.3 × 10⁻² | Absent | 0.50 |
| Example 8 | G | 15 | 17.7 | 1.8 × 10⁻¹ | 3.8 × 10⁻² | Absent | 0.49 |
| Example 9 | B | 5 | 7.7 | 7.7 × 10⁻² | 1.7 × 10⁻² | Absent | 0.35 |
| Example 10 | B | 7 | 9.7 | 9.7 × 10⁻² | 2.1 × 10⁻² | Absent | 0.33 |
| Example 11 | B | 12 | 14.7 | 1.5 × 10⁻¹ | 3.2 × 10⁻² | Absent | 0.31 |
| Example 12 | B | 15 | 17.7 | 1.8 × 10⁻¹ | 3.8 × 10⁻² | Absent | 0.27 |
| Example 13 | B | 20 | 22.7 | 2.3 × 10⁻¹ | 4.9 × 10⁻² | Absent | 0.22 |
| Comparative Example 1 | R | −0.2 | 2.5 | 2.5 × 10⁻² | 5.4 × 10⁻³ | Absent | 0.80 |
| Comparative Example 2 | G | −0.2 | 2.5 | 2.5 × 10⁻² | 5.4 × 10⁻³ | Absent | 0.89 |
| Comparative Example 3 | B | 0.5 | 3.2 | 3.2 × 10⁻² | 6.9 × 10⁻³ | Absent | 0.40 |
| Comparative Example 4 | R | 21 | 23.7 | 2.4 × 10⁻¹ | 5.1 × 10⁻² | Present | — |
| Comparative Example 5 | G | 21 | 23.7 | 2.4 × 10⁻¹ | 5.1 × 10⁻² | Present | — |
| Comparative Example 6 | B | 24 | 26.7 | 2.7 × 10⁻¹ | 5.7 × 10⁻² | Present | — |

In regard to the color filters of Examples 1 to 13, breakdown and color mixing did not occur, and the film thickness difference between the coloring layers of various colors could be made smaller as compared with Comparative Examples 1 to 3.

Furthermore, in Comparative Examples 4 to 6, the coloring layers respectively collapsed at the time of the baking treatment, and color mixing between the adjacent coloring layers occurred.

II. Temperatures of Prebaking Treatment and Post-Baking Treatment

The above-described coloring layer-forming coating liquids of various colors were discharged on the BM substrate by using an inkjet apparatus, and thus a red pre-drying coloring layer, a green pre-drying coloring layer, and a blue pre-drying coloring layer were formed. Incidentally, the coating amounts used at this time were set to the amounts that would give a film thickness of 2.1 μm for the red coloring layer and the green coloring layer and a film thickness of 2.4 μm for the blue coloring layer as the film thicknesses of the coloring layers after the final post-baking treatment. Subsequently, the pre-drying coloring layers of various colors were subjected to a reduced-pressure drying treatment by using a heating reduced-pressure drying apparatus using a hot plate, such that as the film thicknesses of the post-drying coloring layers after reduced-pressure drying, the film thicknesses of the red post-drying coloring layer and the green post-drying coloring layer would be +6 μm with respect to the light shielding part (maximum film thickness: 8.7 μm), and the film thickness of the blue post-drying coloring layer would be +12 μm with respect to the light shielding part (maximum film thickness 14.7 μm). Thus, a color filter substrate was obtained. Incidentally, the temperature of the reduced-pressure drying treatment was set to 40° C.

Substrates for color filter of Examples 14 to 16 and Reference Examples 1 and 2 were formed in the manner as described above, and as shown in Table 2, the substrates were treated for 20 minutes in a clean oven while the temperature conditions for the prebaking treatment were changed, and were subsequently subjected to a post-baking treatment in a clean oven at 230° C. for 40 minutes. Thus, color filters were obtained.

For the respective color filters of Examples 14 to 16 and Reference Examples 1 and 2, the presence or absence of color mixing defects and the difference of the maximum film thickness and the minimum film thickness were investigated. Incidentally, in regard to the evaluation methods, the same methods as those used for the color filters of Example 1 and the like described above were used.

The results are presented in Table 2.

TABLE 2

| | Temperature | | Film thickness | | |
|---|---|---|---|---|---|
| | of prebaking | Breakdown | difference of | | |
| | treatment | and color | coloring layers (μm) | | |
| | (° C.) | mixing | R | G | B |
| Example 14 | 70 | Absent | 0.49 | 0.48 | 0.25 |
| Example 15 | 100 | Absent | 0.50 | 0.51 | 0.33 |
| Example 16 | 110 | Absent | 0.54 | 0.52 | 0.34 |
| Reference Example 1 | 60 | Present | — | — | — |
| Reference Example 2 | 120 | Present | — | — | — |

For the color filters of Examples 14 to 16, breakdown and color mixing did not occur, and the difference between the maximum film thickness and the minimum film thickness of the coloring layers of various colors could be made small. Thus, color filters having highly flat coloring layers could be obtained.

On the other hand, for the color filter of Reference Example 1, breakdown of the blue coloring layer occurred at the time of the post-baking treatment. Also, for the color filter of Reference Example 2, breakdown of the blue coloring layer occurred at the time of the prebaking treatment.

### REFERENCE SIGNS LIST

1 Transparent substrate
2 Light shielding part
3a Pre-drying coloring layer
3b Post-drying coloring layer
10a Black matrix substrate
10b Color filter substrate
10 Color filter
t Maximum film thickness of post-drying coloring layer
u Width of opening

1. A method for producing a color filter, comprising steps of:
an inkjet step of applying a coloring layer-forming coating liquid by an inkjet method at an opening of a black matrix substrate which includes a transparent substrate and a light shielding part that is formed on the transparent substrate and has the opening, and thereby forming a pre-drying coloring layer;
a reduced-pressure drying treatment step of subjecting the pre-drying coloring layer to a reduced-pressure drying treatment, and forming a color filter substrate having a post-drying coloring layer formed thereon; and
a baking treatment step of subjecting the color filter substrate to a prebaking treatment and subsequently to a post-baking treatment, and obtaining a color filter having a coloring layer formed thereon,
wherein, in the reduced-pressure drying treatment step, the pre-drying coloring layer is subjected to the reduced-pressure drying treatment such that a film thickness of an edge of the post-drying coloring layer is not smaller than a film thickness of the light shielding part.

2. A method for producing a color filter, comprising steps of:
an inkjet step of applying a coloring layer-forming coating liquid by an inkjet method at an opening of a black matrix substrate which includes a transparent substrate and a light shielding part that is formed on the transparent substrate and has the opening, and thereby forming a pre-drying coloring layer;
a reduced-pressure drying treatment step of subjecting the pre-drying coloring layer to a reduced-pressure drying treatment, and forming a color filter substrate having a post-drying coloring layer formed thereon; and
a baking treatment step of subjecting the color filter substrate to a prebaking treatment and subsequently to a post-baking treatment, and obtaining a color filter having a coloring layer formed thereon,
wherein, in the reduced-pressure drying treatment step, the pre-drying coloring layer is subjected to the reduced-pressure drying treatment such that a ratio of a maximum film thickness of the post-drying coloring layer and a width of the opening is in the range of 7.8×10⁻³ to 2.3×10⁻¹ when the width of the opening is taken as 1.

3. A method for producing a color filter which comprises a black matrix substrate having a transparent substrate and a light shielding part that is formed on the transparent substrate and has openings, and coloring layers of a plurality of colors formed at the openings on the black matrix substrate, with the coloring layers of a plurality of colors being formed such that a film thickness of a coloring layer of at least one color among the coloring layers of a plurality of colors is smaller than a film thickness of coloring layers of other colors,
the method comprising steps of:
an inkjet step of applying coloring layer-forming coating liquids at the openings of the black matrix substrate by an inkjet method and thereby forming pre-drying coloring layers of a plurality of colors;
a reduced-pressure drying treatment step of subjecting the pre-drying coloring layers of a plurality of colors to a reduced-pressure drying treatment, and forming a color filter substrate having post-drying coloring layers of a plurality of colors formed thereon; and
a baking treatment step of subjecting the color filter substrate to a prebaking treatment and subsequently to a post-baking treatment, and obtaining a color filter having the coloring layers of a plurality of colors formed thereon,
wherein, in the reduced-pressure drying treatment step, the pre-drying coloring layers of a plurality of colors are subjected to the reduced-pressure drying treatment such that a film thickness of an edge of a post-drying coloring layer having the smallest film thickness is not smaller than a film thickness of the light shielding part.

4. A method for producing a color filter which comprises a black matrix substrate having a transparent substrate and a light shielding part that is formed on the transparent substrate and has openings, and coloring layers of a plurality of colors formed at the openings on the black matrix substrate, with the coloring layers of a plurality of colors being formed such that a film thickness of a coloring layer of at least one color among the coloring layers of a plurality of colors is smaller than a film thickness of coloring layers of other colors,
the method comprising steps of:
an inkjet step of applying coloring layer-forming coating liquids at the openings of the black matrix substrate by an inkjet method and thereby forming pre-drying coloring layers of a plurality of colors;
a reduced-pressure drying treatment step of subjecting the pre-drying coloring layers of a plurality of colors to a reduced-pressure drying treatment, and forming a color filter substrate having post-drying coloring layers of a plurality of colors formed thereon; and
a baking treatment step of subjecting the color filter substrate to a prebaking treatment and subsequently to a post-baking treatment, and obtaining a color filter having the coloring layers of a plurality of colors formed thereon,
wherein, in the reduced-pressure drying treatment step, the pre-drying coloring layers of a plurality of colors are subjected to the reduced pressure drying treatment such that a ratio of a maximum thickness of the post-drying coloring layer having the smallest film thickness and a width of the opening is in the range of 7.8×10⁻³ to 2.3×10⁻¹ when the width of the opening is taken as 1.

5. The method for producing a color filter according to claim 3, wherein the coloring layers of a plurality of colors include a red coloring layer, a green coloring layer and a blue coloring layer, and the red coloring layer and the green coloring layer have a same film thickness, while the film thickness of these coloring layers is smaller than a film thickness of the blue coloring layer.

6. The method for producing a color filter according to claim 4, wherein the coloring layers of a plurality of colors include a red coloring layer, a green coloring layer and a blue coloring layer, and the red coloring layer and the green coloring layer have a same film thickness, while the film thickness of these coloring layers is smaller than a film thickness of the blue coloring layer.

7. The method for producing a color filter according to claim 1, wherein, in the baking treatment step, the prebaking treatment is carried out at a temperature in the range of 70° C. to 110° C.

8. The method for producing a color filter according to claim 2, wherein, in the baking treatment step, the prebaking treatment is carried out at a temperature in the range of 70° C. to 110° C.

9. The method for producing a color filter according to claim 3, wherein, in the baking treatment step, the prebaking treatment is carried out at a temperature in the range of 70° C. to 110° C.

10. The method for producing a color filter according to claim 4, wherein, in the baking treatment step, the prebaking treatment is carried out at a temperature in the range of 70° C. to 110° C.
